(19) United States
(12) Patent Application Publication
(10) Pub. No.: US 2024/0214979 A1
(43) Pub. Date: Jun. 27, 2024

(54) SENSING-ASSISTED USER EQUIPMENT TO OBJECT ASSOCIATION

(71) Applicant: QUALCOMM Incorporated, San Diego, CA (US)

(72) Inventors: Yucheng DAI, San Diego, CA (US); Wooseok NAM, San Diego, CA (US); Tao LUO, San Diego, CA (US)

(21) Appl. No.: 18/069,919

(22) Filed: Dec. 21, 2022

(51) Int. Cl. H04W 64/00

(52) U.S. Cl. CPC H04W 64/006

(57) ABSTRACT

A network node may transmit a set of data collection schedules to a first set of network nodes and a first set of user equipment (UEs) to obtain a first set of attributes associated with a user equipment (UE) and a second set of attributes associated with an object associated with an area of interest. The first set of UEs may include the UE. The network node may receive the first set of attributes and the second set of attributes from the first set of network nodes and the first set of UEs based on the set of data collection schedules. The network node may transmit an association of the UE with the object based on the first set of attributes and the second set of attributes.

### TECHNICAL FIELD

The present disclosure relates generally to communication systems, and more particularly, to an object-sensing system.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a network node. The apparatus may transmit a set of data collection schedules to a first set of network nodes and a first set of user equipment (UEs) to obtain a first set of attributes associated with a user equipment (UE) and a second set of attributes associated with an object associated with an area of interest. The first set of UEs may include the UE. The apparatus may receive the first set of attributes and the second set of attributes from the first set of network nodes and the first set of UEs based on the set of data collection schedules. The apparatus may transmit an association of the UE with the object based on the first set of attributes and the second set of attributes.

In an aspect of the disclosure, a method, a computer-readable medium, and an apparatus are provided. The apparatus may include a wireless device. The apparatus may transmit a request to associate a potential association user equipment (PAUE) with an object associated with an area of interest. The apparatus may receive an association of a user equipment (UE) with the object associated with the area of interest based on the request.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of sensing based on measurements of sensing signals reflected off of a target object, in accordance with various aspects of the present disclosure, in accordance with various aspects of the present disclosure.

FIG. 5 is a diagram illustrating an example of a wireless communications system having a plurality of wireless devices, a plurality of objects, and a plurality of areas of interest, in accordance with various aspects of the present disclosure.

FIG. 6 is a communication flow diagram illustrating an example of a wireless device and a network node configured to construct associations between UEs and objects, in accordance with various aspects of the present disclosure.

FIG. 7 is a flowchart of a method of wireless communication.

FIG. 8 is a flowchart of a method of wireless communication.

FIG. 9 is a flowchart of a method of wireless communication.

FIG. 10 is a flowchart of a method of wireless communication.

FIG. 11 is a diagram illustrating an example of a hardware implementation for an example apparatus and/or network entity.

FIG. 12 is a diagram illustrating an example of a hardware implementation for an example network entity.

FIG. 13 is a diagram illustrating an example of a hardware implementation for an example network entity.

FIG. 14 is a diagram illustrating an example of a UE positioning based on reference signal measurements.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media may include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

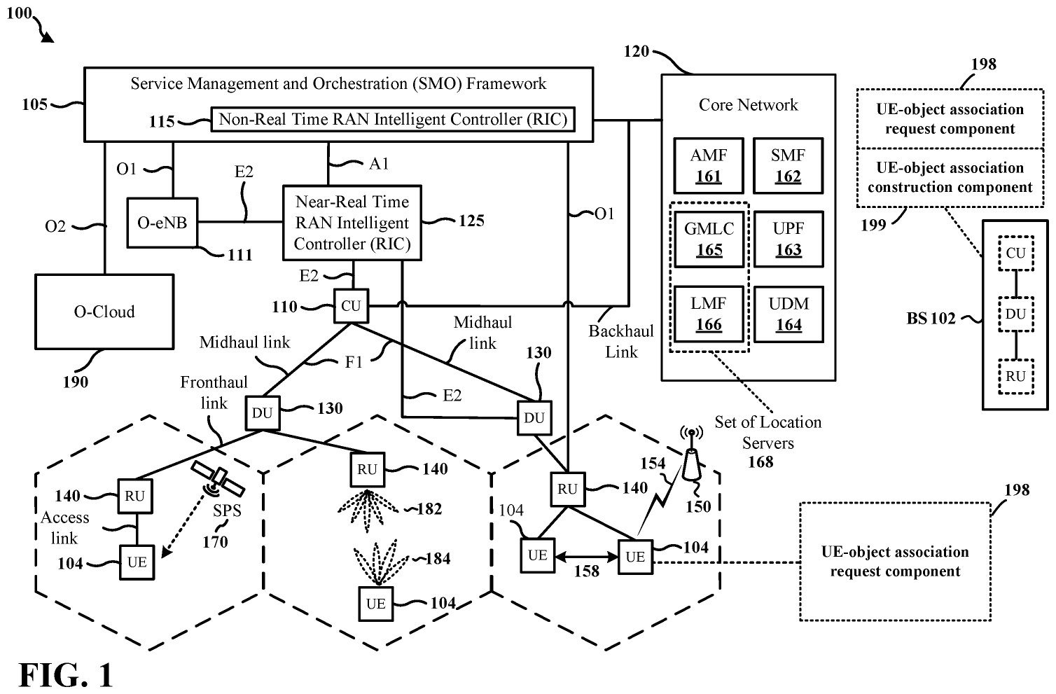

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmission reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 or the base station 102 may have a UE-object association request component 198 that may be configured to transmit a request to associate a potential association user equipment (PAUE) with an object associated with an area of interest. The UE-object association request component 198 may be configured to receive an association of a user equipment (UE) with the object associated with the area of interest based on the request. In certain aspects, the base station 102 may have a UE-object association construction component 199 that may be configured to transmit a set of data collection schedules to a first set of network nodes and a first set of UEs to obtain a first set of attributes associated with a UE and a second set of attributes associated with an object associated with an area of interest. The first set of UEs may include the UE. The UE-object association construction component 199 may be configured to receive the first set of attributes and the second set of attributes from the first set of network nodes and the first set of UEs based on the set of data collection schedules. The first set of UEs may include the UE. The UE-object association construction component 199 may be configured to transmit an association of the UE with the object based on the first set of attributes and the second set of attributes. Although the following description may be focused on association between UEs and target objects that may be sensed using wireless devices, the concepts described herein may be applicable to any wireless devices that may be associated with a target object, such as network nodes or road side units (RSUs). Although the following description may be focused on 5G NR, the concepts described herein may be applicable to other similar areas, such as LTE, LTE-A, CDMA, GSM, and other wireless technologies.

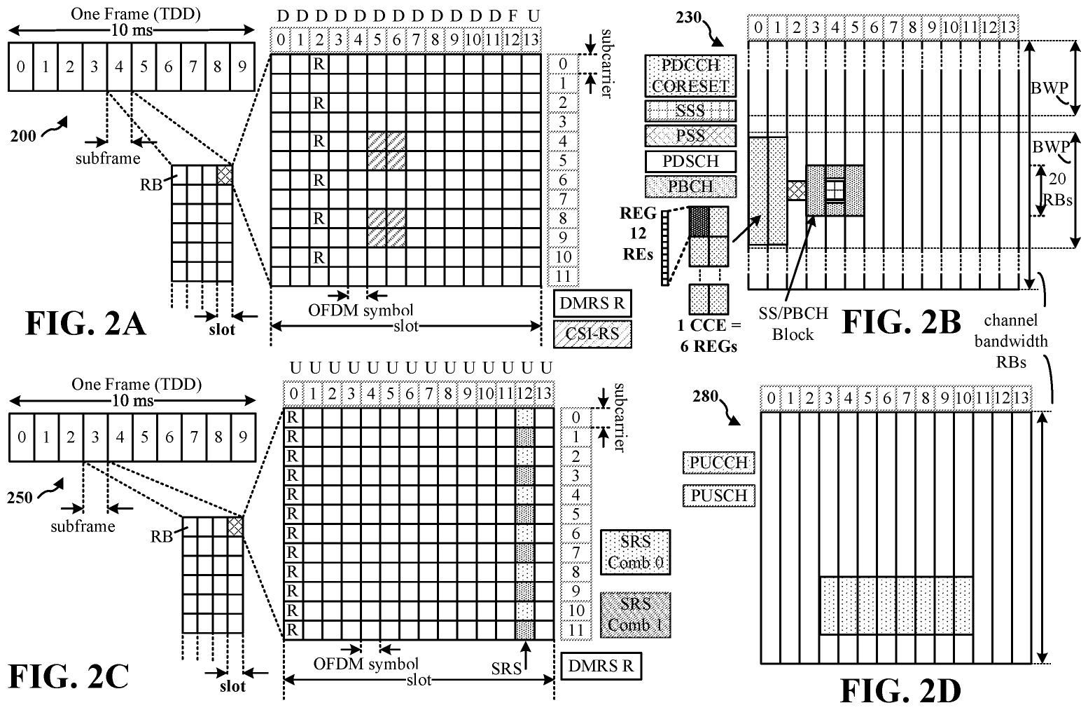

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

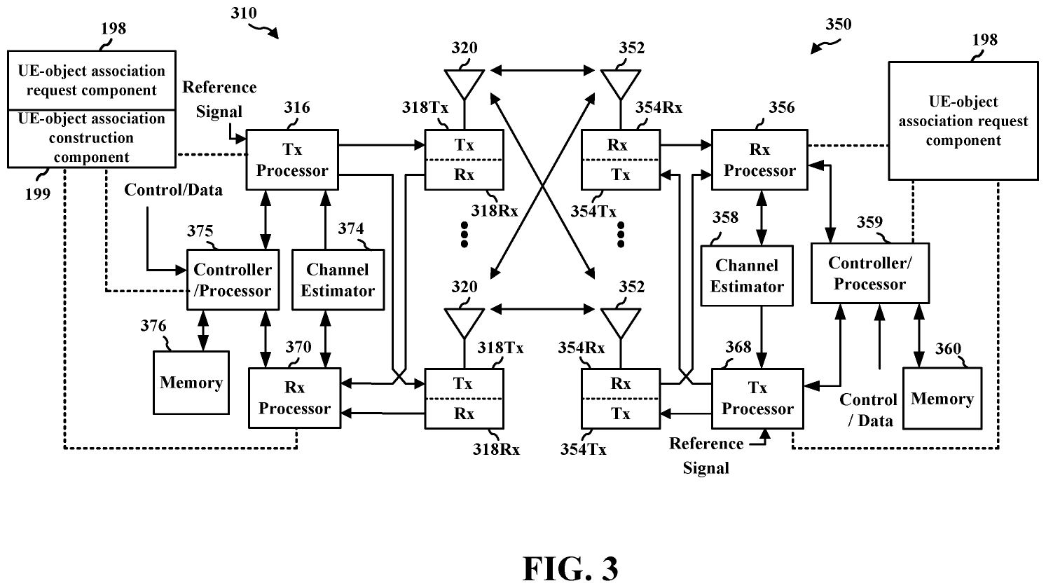

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (Tx) processor 316 and the receive (Rx) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The Tx processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (Rx) processor 356. The Tx processor 368 and the Rx processor 356 implement layer 1 functionality associated with various signal processing functions. The Rx processor 356 may perform spatial processing on the information to recover any spatial streams destined for the UE 350. If multiple spatial streams are destined for the UE 350, they may be combined by the Rx processor 356 into a single OFDM symbol stream. The Rx processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the Tx processor 368 to select the appropriate coding and modulation schemes, and to facilitate spatial processing. The spatial streams generated by the Tx processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a Rx processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the Tx processor 368, the Rx processor 356, and the controller/processor 359 may be configured to perform aspects in connection with the UE-object association request component 198 of FIG. 1.

At least one of the Tx processor 316, the Rx processor 370, and the controller/processor 375 may be configured to perform aspects in connection with the UE-object association request component 198 of FIG. 1.

At least one of the Tx processor 316, the Rx processor 370, and the controller/processor 375 may be configured to perform aspects in connection with the UE-object association construction component 199 of FIG. 1.

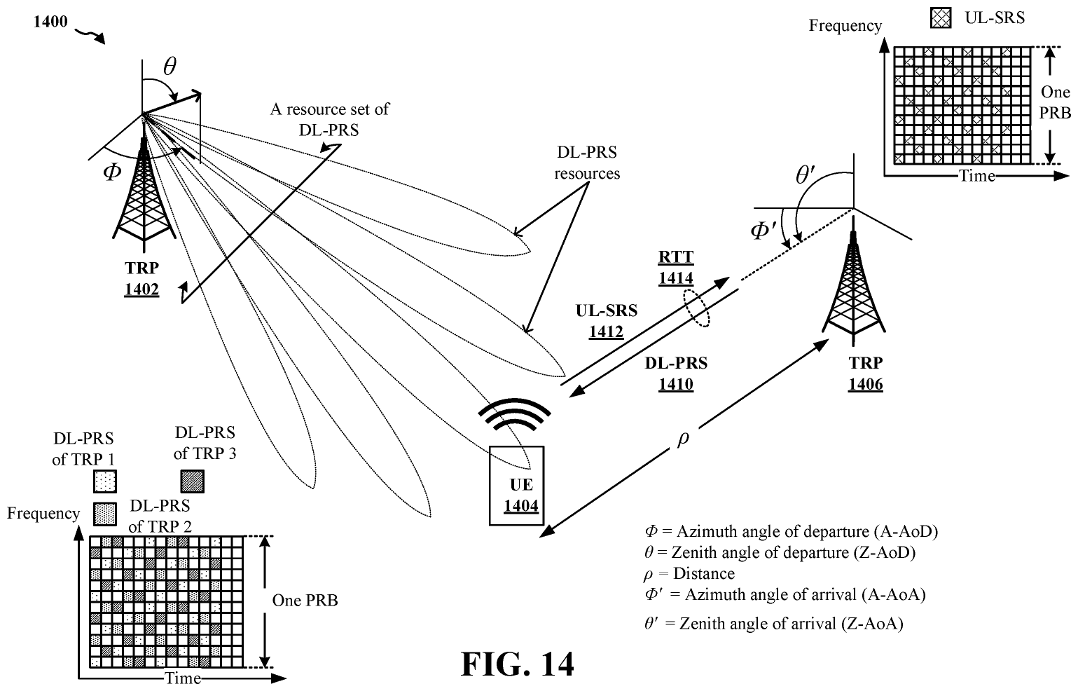

FIG. 14 is a diagram 1400 illustrating an example of a UE positioning based on reference signal measurements. The UE 1404 may transmit UL-SRS 1412 at time T_{SRS_Tx} and receive DL positioning reference signals (PRS) (DL-PRS) 1410 at time T_{PRS_Rx}. The TRP 1406 may receive the UL-SRS 1412 at time T_{SRS_Rx} and transmit the DL-PRS 1410 at time T_{PRS_Tx}. The UE 1404 may receive the DL-PRS 1410 before transmitting the UL-SRS 1412, or may transmit the UL-SRS 1412 before receiving the DL-PRS 1410. In both cases, a positioning server (e.g., location server(s) 168) or the UE 1404 may determine the RTT 1414 based on ∥T_{SRS_Rx}−T_{PRS_Tx}|−|T_{SRS_Tx}−T_{PRS_Rx}∥. Accordingly, multi-RTT positioning may make use of the UE Rx-Tx time difference measurements (i.e., |T_{SRS_Tx}−T_{PRS_Rx}|) and DL-PRS reference signal received power (RSRP) (DL-PRS-RSRP) of downlink signals received from multiple TRPs 1402, 1406 and measured by the UE 1404, and the measured TRP Rx-Tx time difference measurements (i.e., |T_{SRS_Rx}−T_{PRS_Tx}|) and UL-SRS-RSRP at multiple TRPs 1402, 1406 of uplink signals transmitted from UE 1404. The UE 1404 measures the UE Rx-Tx time difference measurements (and DL-PRS-RSRP of the received signals) using assistance data received from the positioning server, and the TRPs 1402, 1406 measure the gNB Rx-Tx time difference measurements (and UL-SRS-RSRP of the received signals) using assistance data received from the positioning server. The measurements may be used at the positioning server or the UE 1404 to determine the RTT, which is used to estimate the location of the UE 1404. Other methods are possible for determining the RTT, such as for example using DL-TDOA and/or UL-TDOA measurements.

DL-AoD positioning may make use of the measured DL-PRS-RSRP of downlink signals received from multiple TRPs 1402, 1406 at the UE 1404. The UE 1404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 1404 in relation to the neighboring TRPs 1402, 1406.

DL-TDOA positioning may make use of the DL reference signal time difference (RSTD) (and DL-PRS-RSRP) of downlink signals received from multiple TRPs 1402, 1406 at the UE 1404. The UE 1404 measures the DL RSTD (and DL-PRS-RSRP) of the received signals using assistance data received from the positioning server, and the resulting measurements are used along with other configuration information to locate the UE 1404 in relation to the neighboring TRPs 1402, 1406.

UL-TDOA positioning may make use of the UL relative time of arrival (RTOA) (and UL-SRS-RSRP) at multiple TRPs 1402, 1406 of uplink signals transmitted from UE 1404. The TRPs 1402, 1406 measure the UL-RTOA (and UL-SRS-RSRP) of the received signals using assistance data received from the positioning server, and the resulting measurements are used along with other configuration information to estimate the location of the UE 1404.

UL-AoA positioning may make use of the measured azimuth angle of arrival (A-AoA) and zenith angle of arrival (Z-AoA) at multiple TRPs 1402, 1406 of uplink signals transmitted from the UE 1404. The TRPs 1402, 1406 measure the A-AoA and the Z-AoA of the received signals using assistance data received from the positioning server, and the resulting measurements are used along with other configuration information to estimate the location of the UE 1404.

Additional positioning methods may be used for estimating the location of the UE 1404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

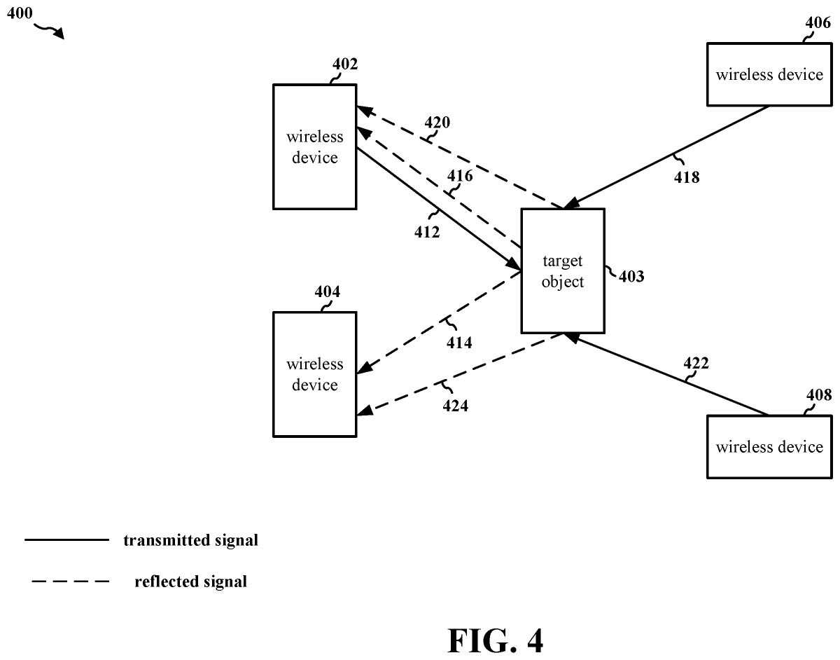

FIG. 4 is a diagram 400 illustrating an example of sensing based on sensing signal measurements. In one aspect, the wireless device 402 may perform monostatic sensing, where the wireless device 402 may transmit a set of sensing signals 412 at the target object 403, the target object 403 may reflect the set of sensing signals 412 as the reflected set of sensing signals 416 at the wireless device 402, and the wireless device 402 may measure the reflected set of sensing signals 416 from the target object 403. In another aspect, the wireless device 402 and the wireless device 404 may perform bistatic sensing, where the wireless device 402 may transmit a set of sensing signals 412 at the target object 403, the target object 403 may reflect the set of sensing signals 412 as the reflected set of sensing signals 414 at the wireless device 404, and the wireless device 404 may measure the reflected set of sensing signals 414 from the target object 403. In another aspect the wireless device 402 and the wireless device 406 may perform multi-static sensing, where in addition to the wireless device 402 measuring the reflected set of sensing signals 416 from the target object 403 using monostatic sensing, the wireless device 406 may transmit a set of sensing signals 418 at the target object 403, the target object 403 may reflect the set of sensing signals 418 as the reflected set of sensing signals 420 at the wireless device 402, and the wireless device 402 may measure the reflected set of sensing signals 420 from the target object 403. In another aspect the wireless device 402, the wireless device 404, and the wireless device 408 may perform multi-static sensing, where in addition to the wireless device 404 measuring the reflected set of sensing signals 414 from the target object 403 using bistatic sensing, the wireless device 408 may transmit a set of sensing signals 422 at the target object 403, the target object 403 may reflect the set of sensing signals 422 as the reflected set of sensing signals 424 at the wireless device 404, and the wireless device 404 may measure the reflected set of sensing signals 424 from the target object 403. Each wireless device may be any wireless device configured to transmit or receive wireless signals, such as UEs, network nodes, TRPs, or base stations. For example, the wireless device 402 may be a network node configured to transmit the set of sensing signals 412 at the target object 403 and measure the reflected set of sensing signals 416 from the target object 403. In another example, the wireless device 402 may be a network node configured to transmit the set of sensing signals 412 at the target object 403, and the wireless device 404 may be a UE configured to measure the reflected set of sensing signals 414 from the target object 403.

The wireless device 402 may conduct one or more sensing measurements on the reflected set of sensing signals 416 and/or the reflected set of sensing signals 420. In one aspect, the wireless device 402 may calculate a distance or a range between the wireless device 402 and the target object 403 based on a round trip time (RTT) between when the wireless device 402 transmits the set of sensing signals 412 and when the wireless device 402 receives the reflected set of sensing signals 416. In one aspect, the wireless device 402 may calculate a distance or a range that the set of sensing signals 418 and the reflected set of sensing signals 420 travels based on a time between when the wireless device 406 transmits the set of sensing signals 418 and when the wireless device 402 receives the reflected set of sensing signals 420. In one aspect, the wireless device 402 may calculate a location of the target object 403 based on a plurality or range or distance measurements, for example via triangulation using known positions of the wireless devices 402 and 406 and the calculated range or distance measurements. In one aspect, the wireless device 402 may calculate a velocity of the target object 403 based on a first calculated location of the target object 403 based on the reflected set of sensing signals 416 and/or the reflected set of sensing signals 420 measured at a first time, and a second calculated location of the target object 403 based on the reflected set of sensing signals 416 and/or the reflected set of sensing signals 420 measured at a second time. In one aspect, the wireless device 402 may calculate an AoA of the reflected set of sensing signals 416 and/or an AoD of the set of sensing signals 412 based on a plurality of ports that transmitted the set of sensing signals 412 and a plurality of ports that received the reflected set of sensing signals 416. In one aspect, the wireless device 402 may calculate an AoA of the reflected set of sensing signals 420 and/or an AoD of the set of sensing signals 418 based on a plurality of ports that transmitted the set of sensing signals 418 and a plurality of ports that received the reflected set of sensing signals 420.

Similarly, the wireless device 404 may conduct one or more sensing measurements on the reflected set of sensing signals 414 and/or the reflected set of sensing signals 424. In one aspect, the wireless device 404 may calculate a distance or a range that the set of sensing signals 412 and the reflected set of sensing signals 414 travels based on a on a time between when the wireless device 402 transmits the set of sensing signals 412 and when the wireless device 404 receives the reflected set of sensing signals 414. In one aspect, the wireless device 404 may calculate a distance or a range that the set of sensing signals 422 and the reflected set of sensing signals 424 travels based on a time between when the wireless device 408 transmits the set of sensing signals 422 and when the wireless device 404 receives the reflected set of sensing signals 424. In one aspect, the wireless device 404 may calculate a location of the target object 403 based on a plurality or range or distance measurements, for example via triangulation using the known positions of wireless devices 402, 404, and 408, and the calculated range or distance measurements. In one aspect, the wireless device 404 may calculate a velocity of the target object 403 based on a first calculated location of the target object 403 based on the reflected set of sensing signals 414 and/or the reflected set of sensing signals 424 measured at a first time, and a second calculated location of the target object 403 based on the reflected set of sensing signals 414 and/or the reflected set of sensing signals 424 measured at a second time. In one aspect, the wireless device 404 may calculate an AoA of the reflected set of sensing signals 414 and/or an AoD of the set of sensing signals 412 based on a plurality of ports that transmitted the set of sensing signals 412 and a plurality of ports that received the reflected set of sensing signals 414. In one aspect, the wireless device 404 may calculate an AoA of the reflected set of sensing signals 424 and/or an AoD of the set of sensing signals 422 based on a plurality of ports that transmitted the set of sensing signals 422 and a plurality of ports that received the reflected set of sensing signals 424. In order to perform Doppler estimates or velocity estimates of a target object, such as the target object 403 in FIG. 4, or of a UE, such as the UE 104 in FIG. 1, the receiver wireless node may be configured to measure a reflected set of sensing signals at multiple points of time.

In some aspects, a wireless device may use the measured sensing signals to generate a position profile of the target object 403. A position profile may include a plurality of attributes of the target object 403 related to its position, for example a location of the target object, a size of the target object, a shape of the target object, an orientation of the target object, a speed of the target object, a velocity of the target object, an acceleration of the target object, a Doppler effect of the target object, a gait of the target object, a routine of the target object, a gesture of the target object, a posture of the target object, a micro-Doppler profile of the target object, or a radar cross-section (RCS) of the target object. In some aspects, a wireless device may determine the RCS based on the measured transmitted and received signal power and the calculated distance of the target object from the wireless device. The wireless device may also measure non-RF wireless signals, such as temperature signals using a temperature sensor, audio signals using an audio sensor or microphone, or light signals using a light sensor or camera. A gait of a target object may be determined by measuring a periodic sequence of foot movements by an animal target object a minimum threshold number of times. A routine of a target object may be determined by measuring a periodic sequence of movements by a dynamic target object a minimum threshold number of times. A gesture of a target object may be determined by measuring a movement of a dynamic target object and comparing the movement to a library of known gestures. Such gesture libraries may include human activities, such as keystrokes on a surface or sign language gestures. A micro-Doppler profile of a target object may include a breathing rate based on expansion and contraction of the chest of a human target object, a heartbeat rate based on an audio signal from the heart of a human target object, or a rotation rate based on a speed of a fan blade of a motorized target object.

A network node or a UE configured to perform measurements on a set of reflected sensing signals may be configured to transmit a sensing signal report to a sensing server (e.g., an LMF) that coordinates a plurality of wireless nodes to perform sensing on a target object. Performing sensing on a target object, such as target object 403, may be viewed as a consumer-level radar with advanced detection capabilities, such as sensing both a position and a temperature of a target object. Configuring a network node to sense such attributes of a target object may be used for touchless or even device-free interaction with a device or system. The network node may use one or more RF signals as a sensing signal, allowing the wireless system to perform both communication and sensing with the same signal. For example, in a 3GPP NR wireless system, a network node may use a millimeter wave (mmWave) RF signal in the frequency range designations of FR2 (24.25 GHz-52.6 GHz), FR2x (52.6 GHz-71 GHz), or FR4 (71 GHz-114.25 GHz) to perform accurate range or distance detection of a target object.

In some aspects, a network node may be configured to detect and monitor an association or a relationship between a UE and an object that may be sensed by a wireless device. For example, a human being object may be holding a UE or may be wearing a container, such as clothing or a bag, that contains the UE. A human may carry a smartphone UE, may wear a smart watch UE, may wear a head-mounted display (HMD) UE, or may wear a backpack or carry a briefcase containing a notebook computer UE. In another example, a vehicle object may have a UE mounted on a surface of the vehicle. A vehicle may be a car, a drone, or an automated guided vehicle (AVG). A vehicle may have an infotainment system UE or an electronic control unit (ECU) UE mounted in the vehicle.

When an object is associated with a UE, a network node may sense the object and the object may be used as a proxy of the UE, or the network node may communicate with the UE and the UE may be used as a proxy of the target object. This allows the network node to track and manage both the UE and the object by communicating with the UE and not sensing the object, or by sensing the object and not communicating with the UE, thereby reducing overhead. A network node may be configured to make such an association permanent or temporary. The network node may sense one or more attributes of an object using one or more perception schemes.

In some aspects, the network node may detect a radar cross-section (RCS) of an object, a micro-Doppler profile of an object, a position of an object, or a temperature of an object. Such attributes may then be associated with a UE that is associated with the object. In one aspect, a network node may perform sensing on an object to assist in performing beam management (BM) on an associated UE or to assist in performing maximum permissible exposure (MPE) detection and/or mitigation on an associated UE. In some aspects, the network node may perform positioning (e.g., LTE positioning or NR positioning) with a UE, may perform sensing on the UE (e.g., if the UE is made of a material that reflects sensing signals better than the object), or more communicate with the UE (e.g., receive a report from a magnetometer or an accelerometer of the UE) to determine attributes of the UE. Such attributes may then be associated with an object that is associated with the UE. In some aspects, a set of UEs may be associated with a set of objects, and the network node may communicate with one of the UEs or may sense one of the objects/UEs to track the entire aggregate set of devices (UEs and objects). In some aspects, a network node may track a lost object or a lost UE by determining when an association between a UE and an object is broken (e.g., the UE is separated from the object by a minimum threshold distance). In some aspects, a UE-object association may be used to enhance public security by using a system that tracks less UEs and/or objects in an area of interest. In some aspects, a UE-object association may be used to track the health of an object (e.g., an elderly patient wearing or holding a UE), and transmit alerts to the UE if a monitored vital sign enters a dangerous threshold range, or trigger a communication between the UE and an emergency device if a monitored vital sign enters a dangerous threshold range.

A wireless device may be configured to transmit a request to associate a potential association user equipment (PAUE) with an object associated with an area of interest. A network node may receive the request and transmit an enquiry to a set of network nodes and a set of PAUEs to determine the capabilities of the set of network nodes and the capabilities of the set of PAUEs, respectively. The network node may then select a subset of the set of network nodes and a subset of the set of PAUEs as potential devices that may be used to create associations between a UE and an object. The network node may select the subsets based on the capabilities of the network nodes and PAUEs (e.g., capability of a network node to sense objects within an area of interest, capability of a PAUE to maintain an association with an object). The network node may be configured to transmit a set of data collection schedules to the subset of network nodes and the subset of PAUEs to obtain a first set of attributes associated with a UE and a second set of attributes associated with the object associated with the area of interest. The subset of PAUEs may include the UE. The network node may receive the first set of attributes and the second set of attributes from the subset of network nodes and the subset of UEs based on the set of data collection schedules. The network node may transmit an association of the UE with the object based on the first set of attributes and the second set of attributes. The wireless device may receive the association of the UE with the object associated with the area of interest based on the request.

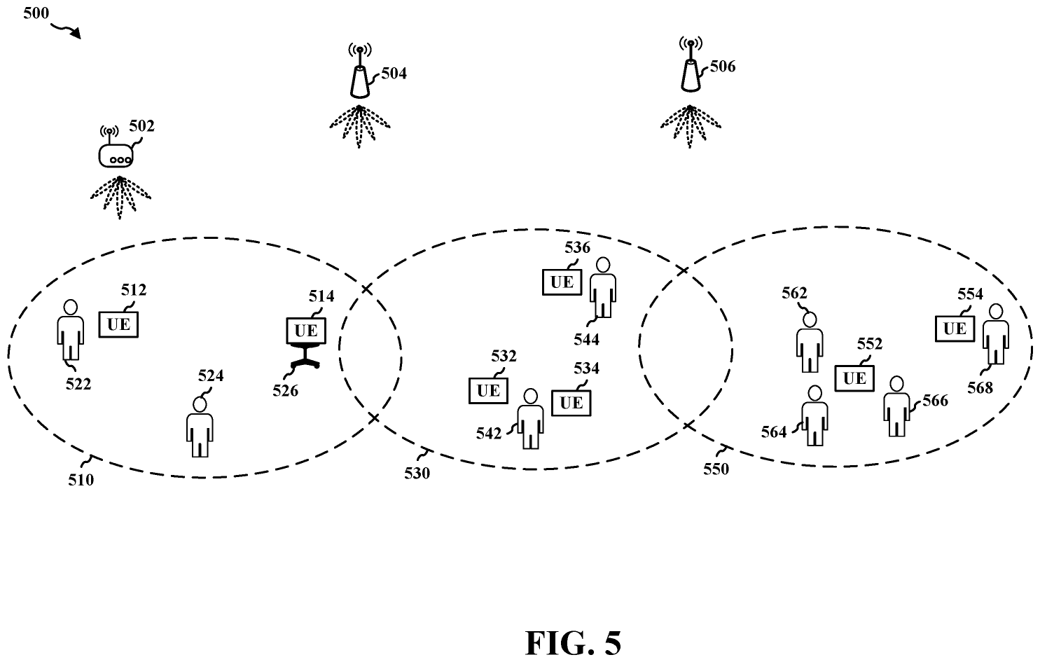

FIG. 5 is a diagram 500 illustrating an example of a wireless communications system having an area of interest 510, an area of interest 530, and an area of interest 550. A Each of the areas of interest may be associated with a set of network nodes and a set of UEs. For example, the area of interest 510 may be associated with the RSU 502, the TRP 504, the UE 512, and the UE 514. The area of interest 530 may be associated with the TRP 504, the TRP 506, the UE 536, the UE 532, and the UE 534. The area of interest 550 may be associated with the TRP 506, the UE 552, and the UE 554. The associated network nodes and/or the associated UEs may be considered wireless devices configured to sense objects within the area of interest 510 using monostatic sensing or bistatic sensing. For example, each of the RSU 502, the TRP 504, the UE 512, and/or the UE 514 may be configured to sense one or both of the object 522 or the object 524 in the area of interest 510. Each of the TRP 504, the TRP 506, the UE 536, the UE 532, and the UE 534 may be configured to sense one or both of the object 542 or the object 544 in the area of interest 530. Each of the TRP 506, the UE 552, and the UE 554 may be configured to sense one or each of the object 562, the object 564, the object 566, or the object 568 in the area of interest 550. The wireless devices may use monostatic sensing to transmit a sensing signal to the object and measure the reflected sensing signal from the object, or may cooperate with one another to transmit a sensing signal to the object, which may then be measured by another wireless device to measure the reflected sensing signal from the object. The wireless devices may indicate what kinds of sensors the sensing wireless device may use to gather data from a target object, such as an RF antenna, a LIDAR sensor, a SONAR sensor, a visual camera, a thermal camera, or an audio microphone. A wireless device positioned close to an object may be configured to measure attributes of the object with a higher degree of accuracy than a wireless device positioned further away from the object. For example, the UE 512 may be configured to generate a micro-Doppler profile of the object 522 (e.g., measure a heartbeat of a human or measure a breathing rate of a person), while the RSU 502 may not be able to measure such attributes of the object 522 with such a high degree of accuracy since the UE 512 is in closer physical proximity to the object 522. In another example, the RSU 502 may be configured to detect gestures or gaits of the object 522 (e.g., determine if the object 522 is waving or kicking, or determine if the object 522 is skipping or hopping), but the TRP 504 may not be able to measure such attributes of the object 522 with such a high degree of accuracy since the RSU 502 is in closer physical proximity to the object 522 than the TRP 504. In some aspects, a wireless device or a network node may be configured to calculate the degree of accuracy of a wireless device based upon at least one of its distance from an object, a strength of its sensor receiving the reflected sensing signal, or a strength of the sensing signal transmitted to the object.

In addition to performing sensing, the UEs in an area of interest may be configured to report attributes associated with the UE. In some aspects, a UE may be configured to report beam and channel state information (CSI) reference signal (CSI-RS) measurements, radio resource management (RRM) measurements, or sounding reference signal (SRS) transmission measurements. Such measurements may be used to indicate which UEs have the strongest or most reliable beam connections to network nodes, and beam directions for positioning measurements. In another aspect, a UE may be configured to report positioning reference signal (PRS) measurements, SRS positioning measurements, or measurements using other sensors (e.g., a barometer, a GNSS device, an inertial measurement unit (IMU). Such measurements may be used to indicate a position of the UE, and/or movement information of the UE.

A network node may be able to construct an association between a UE and an object based on attributes associated with the object collected by using sensing and based on attributes associated with a UE collected by communicating with the UE or by using sensing. For example, a network node may associate the UE 512 with the object 522 by determining that the position of the UE 512 is within a threshold distance of the object 522, and/or by determining that a shape profile of the object 522 indicates that the object 522 is holding the UE 512. In another example, a network node may associate the UE 514 with the object 526 by determining that the object 526 has a shape profile that indicates that the UE 514 is mounted on the object 526. In another example, a network node may associate both the UE 532 and the UE 534 with the object 542 by determining that both the UE 532 and the UE 534 are within a threshold distance of the object 542. In another example, a network node may associate the UE 552 with the object 562, the object 564, and the object 566 by determining that the UE 552 is within a threshold distance of the object 562, the object 564, and the object 566 for a period of time while the UE 552, the object 562, the object 564, and the object 566 are moving. In another aspect, a network node may not associate the object 524 with a UE if there is no UE within a threshold distance of the object 524. When a network node associates a set of UEs with a set of objects, the network node may use attributes of one of the associated UEs or objects to derive attributes of the other associated UEs or objects. For example, if a network node associates the object 542 with the UE 532 and the UE 534, the network node may perform positioning on the UE 532 to derive a position of the object 542, and the UE 534, or may perform sensing on the object 542 to derive a position of the UE 532 and the UE 534. Similarly, if a network node associates the UE 552 with the object the object 562, the object 564, and the object 566, then the network node may perform sensing on the object 564 to derive a position of the UE 552, the object 562 and the object 566, or may perform positioning on the UE 552 to derive a position of the object 562, the object 564, and the object 566. As a result, the network node may be able to track a position or a movement of a UE by tracking a position of an object, or vice-versa, and may be able to track a position or movement of a plurality of UEs and/or a plurality of objects by tracking a position or movement of a single UE or a single object.

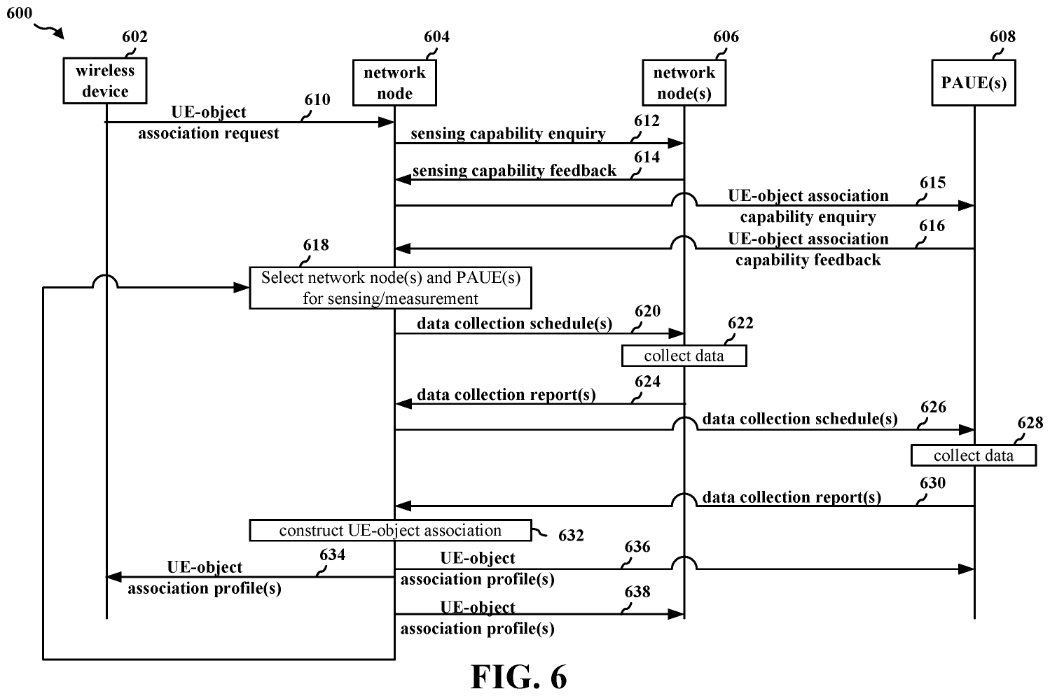

FIG. 6 is a communication flow diagram 600 illustrating an example of a wireless device 602 and a network node 604 configured to construct associations between one or more PAUEs and one or more objects. A PAUE may be any UE that may potentially be associated with an object, but has not yet been associated with that object. The associations between PAUEs and objects may be made using sensing data collected from a set of network nodes 606 and/or a set of PAUEs 608 and using UE information collected about the set of PAUEs 608. The wireless device 602 may be a UE other than the set of PAUEs 608, one of the PAUEs 608, a network node other than the set of network nodes 606, or one of the network nodes 606. In other words, while the wireless device 602 is shown in FIG. 6 is as a device that is separate from the network node 604, the set of network nodes 606, and the set of PAUEs 608, in some aspects the wireless device 602 and the network node 604 may be the same device (e.g., the network node 604 may generate and initiate a UE-object association request on its own), the wireless device 602 may be one of the set of network nodes 606 (e.g., the wireless device 602 may collect sensing data associated with objects in an area of interest, sensing data associated with the set of PAUEs 608, and/or attribute data associated with the set of PAUEs 608), or the wireless device 602 may be one of the set of PAUEs 608 (e.g., the wireless device 602 may be a UE that is a candidate for association with an object sensed by the set of network nodes 606 and/or the set of PAUEs 608). The network node 604 may be a network node other than the set of network nodes 606 (e.g., the network node 604 may be a sensing server, a TRP, or an LMF requesting data from the set of network nodes 606), or the network node 604 may be one of the set of network nodes 606 (e.g., the network node 604 may collect data from objects and/or PAUEs in an area of interest.

The wireless device 602 may transmit a UE-object association request 610 to the network node 604. The network node 604 may receive the UE-object association request 610. The network node 604 may serve as a centralized coordinator of the UE-object association procedure for the UE-object association request 610. The UE-object association request 610 may be transmitted in any suitable manner, for example via a radio resource control (RRC) message, a UE assistance information message, a long term evolution (LTE) positioning protocol (LPP) message, a medium access control (MAC) control element (MAC-CE), downlink control information (DCI), an uplink control information (UCI) message, a physical uplink control channel (PUCCH) message, or a physical random access channel (PRACH) message including the request. The UE-object association request 610 may include an indication of an area of interest of an object or a group of objects, such as coordinates in a three-dimensional space, a relative position from the network node 604, a relative position from the wireless device 602, or a synchronization signal (SSB) index of an SSB beam. For example, the UE-object association request 610 may include an instruction to associate UEs and objects within the area of interest 510, UEs and objects within the area of interest 530, and/or UEs and objects within the area of interest 550 in FIG. 5. The UE-object association request 610 may include an indication of a set of UEs of interest, such as identifiers (ID) of the set of PAUEs 608, and/or an indication of an area of interest of the set of PAUEs 608 (e.g., the network node 604 may analyze an indication of an area of interest, and determine that the set of PAUEs 608 are all known UEs within the area of interest with the capability, or potential capability, to be associated with an object). The set of UEs indicated by the UE-object association request 610 may include a set of UEs discovered by the wireless device 602 via a sidelink discovery process, or may include an indication of a set of UEs within a set of coverage areas, zones, or areas of interest of a network node, such as an RSU or a TRP. For example, the UE-object association request 610 may include an indication of an RSU (e.g., an RSU ID), and may indicate for objects to be associated with as many UEs as possible which the RSU may communicate with. The network node 604 may then query the RSU to determine the set of UEs that are within communication range of the RSU. The UE-object association request 610 may include an indication of a previous UE-object association profile, such as an indicator of a UE-object association profile associated with an object of interest (e.g., all UE-object profiles previously associated with the object), and/or an indicator of a UE-object association profile associated with a UE of interest (e.g., all UE-object profiles previously associated with the UE). The UE-object association request 610 may include a set of UEs for association with objects.

In response to receiving the UE-object association request 610, the network node 604 may initiate a UE-object association procedure by collecting capabilities of a set of network nodes 606 to determine if a network node is suitable for UE-object association. The set of network nodes 606 may include TRPs, base stations, or RSUs. The set of network nodes 606 may include the network node 604. The network node 604 may select the set of network nodes based on the UE-object association request 610. In one aspect, the UE-object association request 610 may include an indicator of a set of network nodes, such as a set of cell IDs, which the network node 604 may use to select a set of network nodes whose cell IDs include the indicated set of cell IDs. In another aspect, the UE-object association request 610 may indicate an area of interest or a set of device IDs or object IDs that indicates an area of interest, which the network node 604 may use to select a set of network nodes that are configured to sense objects within one or more areas of interest. In some aspects, the network node 604 may perform sensing about at least a portion of the area of interest to obtain information about devices about the area of interest, such as the number and types (with an object classification algorithm) of objects around the area of interest, which may include network nodes. The network node 604 may then identify some of the set of network nodes 606 based on the sensing data. In other words, based on the location information, or device IDs, provided in the UE-object association request 610, the network node 604 may check if there are any available network nodes, or sensing devices, which may sense objects within the area of interest. If such network nodes exist, the network node 604 may send an enquiry to the network nodes to check their sensing capabilities. The network node 604 may transmit a sensing capability enquiry 612 to the set of network nodes 606. The set of network nodes 606 may receive the sensing capability enquiry 612.

In response to receiving the sensing capability enquiry 612, the set of network nodes 606 may transmit capability information to the network node 604 as the sensing capability feedback 614. In other words, the network node 604 may collect capabilities of a set of sensing network nodes. The sensing capability feedback 614 may be referred to as sensing capability information or as attributes of sensing measurements that may be reported by a sensing network node to a coordinator network node. The sensing capability information may include positioning capability, cooperative sensing capability, MPE detection capability, or what kinds of sensors the sensing network node may use to measure the object. The sensing capability information may include whether the sensing network node may perform monostatic sensing of objects (i.e., transmitting a sensing signal at a target object and measuring a reflected sensing signal from the target object). The sensing capability information may include whether the sensing network node may perform bistatic cooperative sensing of objects (i.e., transmitting a sensing signal at a target object whose reflected sensing signal is received and measured by another wireless device or receiving and measuring a reflected sensing signal that originated from another wireless device that transmitted the sensing signal at the target object). The sensing capability information may include what kinds of sensors the sensing network node may use to gather data from a target object, such as an RF antenna, a LIDAR sensor, a SONAR sensor, a visual camera, a thermal camera, or an audio microphone.

In response to receiving the UE-object association request 610, the network node 604 may initiate a UE-object association procedure by collecting capabilities of a set of PAUEs 608 to determine if a PAUE is suitable for UE-object association. For example, the network node 604 may query a set of PAUEs in an area of interest to determine which of the PAUEs in the area of interest are capable of being associated with an object. In some aspects, any UE that is capable of performing sensing on an object within a threshold range (e.g., 5 meters of the UE) may be determined to be capable of a UE-object association. The set of PAUEs 608 may include any wireless devices, including moving or fixed network nodes (e.g., TRPs, base stations, or RSUs), as an object may be stationary or affixed to a structure attached to a network node. The set of PAUEs 608 may include the wireless device 602. The network node 604 may select the set of PAUEs 608 based on the UE-object association request 610. In one aspect, the UE-object association request 610 may include an indicator of a set of PAUEs, such as a set of UE IDs, which the network node 604 uses to select a set of PAUEs that are associated with the indicator of the set of PAUEs. In another aspect, the UE-object association request 610 may indicate an area of interest or a set of device IDs or object IDs that indicates an area of interest, which the network node 604 uses to select a set of PAUEs 608 that are configured to sense objects within one or more areas of interest or a set of PAUEs that are configured to communicate with a network node having a coverage areas that overlaps with one or more of the areas of interest. In another aspect, the UE-object association request 610 may indicate a set of UEs in the service range of the wireless device 602 (e.g., a set of UEs discovered using a sidelink discovery process, a set of UEs within a zone of an RSU), which the network node 604 uses to select a set of PAUEs 608 that are within the service range of the wireless device 602. The network node 604 may transmit a UE-object association capability enquiry 615 to the set of PAUEs 608. The set of PAUEs 608 may receive the UE-object association capability enquiry 615 from the network node 604.

In response to receiving the UE-object association capability enquiry 615, the set of PAUEs 608 may transmit capability information to the network node 604 as the UE-object association capability feedback 616. In other words, a network node 604 may collect capabilities of a set of PAUEs. The UE-object association capability feedback 616 may be referred to as PAUE capability information or as UE capability information that may be reported by a PAUE to a coordinator network node. The PAUE capability information may include positioning capability, cooperative sensing capability, MPE detection capability, or what kinds of sensors the UE may use to measure the object. The PAUE capability information may include sensing capability information, attributes of sensing measurements that may be reported by the PAUE to the coordinator network node, the PAUE's capability to report the quality of wireless links with other devices, the PAUE's capability to report the quality of wireless beams, the PAUE's capability to convey it's position, the PAUE's capability to convey it's movement, the PAUE's capability to report sensing measurements, or the PAUE's capability to report UE assistance information for UE-object association. The PAUE capability information may include whether the UE may perform monostatic sensing of objects (i.e., transmitting a sensing signal at a target object and measuring a reflected sensing signal from the target object). The PAUE capability information may include whether the UE may perform bistatic cooperative sensing of objects (i.e., transmitting a sensing signal at a target object whose reflected sensing signal is received and measured by another wireless device or receiving and measuring a reflected sensing signal that originated from another wireless device that transmitted the sensing signal at the target object). The PAUE capability information may include what kinds of sensors the UE may use to gather data from a target object, such as an RF antenna, a LIDAR sensor, a SONAR sensor, a visual camera, a thermal camera, or an audio microphone. The PAUE's capability to report the quality of wireless links with other devices or the PAUE's capability to report the quality of wireless beams may include information on the UE's capability to report beam measurements, channel state information (CSI) reference signal (CSI-RS) measurements, radio resource management (RRM) measurements, or sounding reference signal (SRS) transmission measurements. The PAUE's capability to convey its position or the PAUE's capability to convey its movement may include information on the UE's capability to report positioning reference signal (PRS) measurements, the UE's capability to transmit SRSs for positioning, or the UE's capability to report its position using other sensors (e.g., an inertial measurement unit (IMU) sensor, a barometer, a GNSS device, a magnetometer, an accelerometer). The PAUE's capability to report sensing measurements may include whether the UE may perform monostatic sensing of objects, whether the UE may perform bistatic sensing of objects, whether the UE may detect MPE metrics, or the types of measurements that the UE may measure (e.g., RF, light, temperature, audio). The PAUE's capability to report UE assistance information for UE-object association may include the types of characteristics that the UE may detect, for example whether the UE may construct a micro-Doppler profile of the object, whether the UE may detect RCS of the object, what types of motions of the object the UE may detect (e.g., speed, gait, routine), whether the UE may detect a shape of the object, what kinds of shapes the UE may detect, whether the UE may detect an orientation of the object, or whether the UE may detect a temperature of the object.

At 618, the network node 604 may select network nodes and PAUEs to use to collect attributes associated with the object and/or attributes associated with the PAUEs based on the capability information from the set of network nodes 606 and the capability information from the set of PAUEs 608. In some aspects, the network node 604 may increase or decrease the number of network nodes selected for the set of network nodes 606 based on the sensing results. For example, the network node 604 may increase the number of network nodes used for sensing if there are a lot of objects within an area of interest (e.g., greater or equal to a threshold value), or may decrease the number of network nodes used for sensing if there are fewer objects within an area of interest (e.g., less than or equal to the threshold value). The decision may be based on information of a previous or a periodic sensing result (e.g., how many objects moving over a threshold speed are within an area of interest), information of the available network nodes and/or PAUEs that may sense objects within the area of interest (e.g., the number of UEs in an area of interest), and/or the reported information from the set of PAUEs 608. In some aspects, the network node 604 may select all network nodes capable of sensing objects within an area of interest, and all known UEs that are within an area of interest. In other aspects, the network node 604 may select all network node and all UEs that are capable of sensing objects within an area of interest. In some aspects, the network node 604 may select UEs within an area of interest that are capable of reporting sensing information in an area of interest, the UE's position as it moves within the area of interest, and link and beam attributes (e.g., beam and CSI measurement reporting), as such capabilities may help maintain a UE-object association over time. In other words, based on the sensing capability feedback 614 from the set of network nodes 606 and/or the UE-object association capability feedback 616 from the set of PAUEs 608, the network node 604 may configure a subset of the set of network nodes 606 and a subset of the set of PAUEs 608 for sensing measurement and reporting. The subset of the set of network nodes 606 may be the set of network nodes 606. The subset of the set of PAUEs 608 may be the set of PAUEs 608. Such information may be used for UE-object association.

The network node 604 may determine which data should be collected at each of the set of network nodes 606 based on the sensing capability feedback 614 and each of the set of PAUEs 608 based on the UE-object sensing capability feedback 616. Power consumption and data size corresponding to different types of measurements may be a factor affecting choice of measurements. For example, the network node 604 may determine that the set of network nodes 606 may collect more sensing measurement data than the set of PAUEs 608 in response to determining that the set of network nodes 606 have no power consumption limitations, and the set of PAUEs 608 have power consumption limitations. In some aspects, the network node 604 may assign a power value to each type of sensing measurement, may prioritize sensing measurements in a priority list, and may assign sensing measurements to the set of PAUEs from the highest priority measurements to the lowest priority measurements until a threshold power value is reached, or before a threshold power value is reached. Different UE-object association methods may be associated with different sensing measurements. For example, some data-driven techniques, like a trained data-fusion convolutional neural network (CNN) may be associated with the input data to be in a specific format. The network node 604 may be configured to determine which data should be collected in response to a UE-object association method selected by the network node 604. For example, the UE-object association request 610 may identify a first UE-object association method that uses RF sensing and radar sensing to sense objects about the PAUE (e.g., recognize objects via measuring RF signals), or a second UE-object association method that uses LIDAR and camera sensors to sense objects about the PAUE (e.g., recognize objects via image recognition).

The network node 604 may transmit a set of data collection schedules 620 to the subset of the set of network nodes 606. The set of network nodes 606 may receive the set of data collection schedules 620. In some aspects, the network node 604 may transmit one of the set of data collection schedules 620 to each of the set of network nodes 606. The network node 604 may arrange measurement time slots for collecting the data at 622 and at 628. To match the measurements at the set of network nodes 606 and the set of PAUEs 608, the network node 604 may configure the data collection to occur at the same time, or to share an overlapped period of time. This is because, in an area of interest with a relatively large number of potential objects, asynchronized measurements may lead to wrong UE-object association, as a UE may report its location to be a first position, one of the set of network nodes 606 may sense an object at the first position, but the UE may have moved from the first position if the location of the UE and the sensing of the object occur during different time periods. In some aspects, the network node 604 may arrange measurement time slots for collecting the data at 622 and at 628 to be within a maximum threshold time period (e.g., all measurements happening between two time indicators, such as a 5-second period of time). In some aspects, a wireless device may have an onboard sensor (e.g., a camera, a LIDAR sensor, a RADAR sensor, a temperature sensor) that has a sleep/wake work schedule. The network node 604 may schedule a wake-up signal for a sensor in order for data to be collected by the sensor during a scheduled time period. In some aspects, the network node 604 may instruct a wireless device to report the collected data with an associated time stamp, allowing the network node 604 to appropriately associate asynchronized measurements. For example, a first data collection report may indicate an object moving in a first direction at a first velocity, and a second data collection report may indicate a UE moving in a second direction at a second velocity. While the data may be collected at different times, by using time stamps associated with the collected data, the network node 604 may determine that there is a high likelihood of the object and the UE moving in the same direction at the same velocity at the same time, and associated the UE with the object.

The network node 604 may configure the set of data collection schedules 620 for the set of network nodes 606 and the set of data collection schedules 626 for the set of PAUEs 608 with an indication of sensing measurements to report, a time schedule to measure, what attributes to report, and other detailed settings for different types of measurements. The association measurement indication may be in a standard format, such as using one digit to indicate whether or not to collect data for a certain type of measurement. A string of digits may be transmitted to indicate which measurements a wireless device should collect. The association measurement indication may have a plurality of parameters. For example, for a camera sensor, the association measurement indication may indicate which camera to use, what resolution to use (e.g., 640×320 resolution), and what frame rate to use (e.g., 30 frames per second (fps)). At 622, the subset of the set of network nodes 606 may collect data, such as sensing data of objects or UEs in an area of interest. Each of the subset of the set of network nodes 606 may generate a data collection report, such as attributes of objects sensed by the network node in an area of interest, attributes of PAUEs sensed by the network node in an area of interest, beam quality information with respect to PAUEs in an area of interest, or position information of PAUEs in an area of interest. The subset of the set of network nodes 606 may transmit a set of data collection reports 624 to the network node 604. The network node 604 may receive the set of data collection reports 624.

The network node 604 may transmit a set of data collection schedules 626 to the subset of the set of PAUEs 608. The set of PAUEs 608 may receive the set of data collection schedules 626. The set of data collection schedules 626 may be transmitted in a plurality of ways, for example via an RRC message, a MAC-CE, or DCI. In some aspects, the network node 604 may broadcast the set of data collection schedules 626 to all UEs. The set of data collection schedules 626 may include an indicator of which UEs should collect data, for example a set of UE IDs associated with the set of PAUEs 608. At 628, the subset of the set of PAUEs 608 may collect data, such as sensing data of objects or UEs in an area of interest, or UE link and beam quality reports, UE position and movement information, or UE assistance information for UE-object association. Each of the subset of the set of PAUEs 608 may generate a data collection report, such as attributes of objects sensed by the PAUE in an area of interest, attributes of other UEs sensed by the PAUE in an area of interest, beam quality information with respect to PAUE, position information, movement information, or UE assistance information such as micro-Doppler profiles or RCS information. The subset of the set of PAUEs 608 may transmit a set of data collection reports 630 to the network node 604. The network node 604 may receive the set of data collection reports 630. The set of PAUEs 608 may transmit the set of data collection reports 630 in a plurality of manners, for example via RRC (e.g., UE assistance information or an LPP message), MAC-CE, a UCI message, a PUUCH message, or a PRACH message.

At 632, the network node 604 may construct one or more UE-object associations based on the collected data. The association may be based on one or more shared associations, such as a shared position, a shared movement or position change pattern, a shared Doppler profile, a shared speed change pattern, CSI reports having shared attributes, or a posture of a user. A shared metric may be two metrics that are within a threshold tolerance of one another, such as a 2% tolerance or a 5% tolerance. For example, a shared position between a UE and an object may be positions within 1 meter of one another. In some aspects, the network node 604 may associate a UE with an object based on a beam direction, or a beam direction change pattern. For example, the network node 604, or the set of network nodes 606, may obtain a beam direction, or a beam direction change pattern, for each of the set of PAUEs 608 based upon communications with the set of PAUEs 608 (e.g., via beam management (BM)). The network node communicating with the UE may compare the beam direction match or closeness (based on a metric) between the communication beam (acquired by BM) and a sensing beam of an object (acquired by monostatic sensing at the serving TRP). If the beam direction, or the beam direction change pattern, for both the UE and the object is shared, or within a threshold distance of one another, the network node 604 may associate the UE and the object with one another. In some aspects, a posture of the object may be used to associate a UE. For example, network node may detect that an object close to the UE has a high probability of being a human that holds a mobile phone, and the UE close to the object may have a reported device type of a mobile phone. In response, the network node 604 may associate the UE with the object. The posture of the object may be associated with a type of UE. The posture may be sensed via monostatic sensing at a PAUE or at a network node, or via a camera or a LIDAR sensor. The network node or the PAUE may be configured to sense a posture of a human object with a relatively high accuracy depending upon which sensors are used to sense the object.

In some aspects, the network node 604 may associate a UE with an object based on a position of the UE and a position of the object. The position of a PAUE of the set of PAUEs 608 may be determined in a plurality of manners, for example by the PAUE performing positioning using PRS and SRS measurements with a set of TRPs, by performing a GNSS fix, or by performing positioning with an LMF. The network node 604 may compare the reported position of each of the set of PAUEs 608 with the reported position of each of the objects within an area of interest to determine an association between each PAUE and each object based on a maximum distance tolerance threshold (e.g., within 1 meter). If multiple sensed objects are within the maximum distance tolerance threshold, the network node 604 may select all of the objects, or may select the closest object. In some aspects, the network node 604 may track movement of a potentially associated UE and object to improve reliability (e.g., the network node 604 may associate a UE and an object if they are found within the same maximum distance threshold of one another for a threshold period of time, or at a number of periods of time while moving). If a PAUE relies on positioning to obtain its position, a PRS trigger sensing process may be applied to synchronization at both the client and sensing device side.

In some aspects, the network node 604 may associate a UE with an object based on a Doppler pattern, speed, or speed change pattern of the UE and a Doppler pattern, speed, or speed change pattern of the object, respectively. In some aspects, a PAUE may use an IMU to determine a speed of the PAUE. In some aspects, a PAUE may report its speed with a time stamp, or a speed change pattern with a plurality of time stamps, which may used as complementary information with positioning or beam direction or beam change patterns discussed above.

In some aspects, the network node 604 may associate a UE with an object based on a CSI report of the UE and a Doppler pattern, speed, or speed change pattern of the object, respectively. Such information may also be correlated with a position, beam direction, or beam change pattern of the object or the UE. In some aspects, the network node 604 may use machine learning (ML) to determine how a CSI report may be correlated with the other measurements to increase or decrease a likelihood that a CSI report is correlated with a measurement.

The network node 604 may use some or all of the above-referenced correlative measurements to associate a UE with an object. To improve the accuracy of an association, the network node 604 may jointly process the measurements via a data-fusion decision-making algorithm, such as an ML-based algorithm trained using known associated UEs and objects, and then applied to PAUEs and objects.

The network node 604 may construct a UE-object association profile that includes an association between a set of objects and a set of UEs, such that the network node 604 may associate attributes of one of the elements of the UE-object association profile with other elements of the UE-object association profile. The UE-object association profile may include an identifier of each of the set of UEs and unique information associated with each of the set of objects (e.g., a position, a size, a shape, an orientation, a speed, or a micro-Doppler profile). The network node may share the UE-object association profile via a backhaul link with other network nodes, such as adjacent TRPs or other network nodes that cover an area of interest that one of the set of UEs or one of the set of objects may move into. In some aspects, the network node 604 may be configured to associate one UE with one object, in which case the profile may have binary indicators, such as a yes/no indicator of whether an object is associated with an ID, along with a field for a UE ID. The network node 604 may also assign an association maintenance metric to an association based upon the measurements used to associate the UE and object together. For example, the network node 604 may configure a UE-object association formed using a shared beam direction to be maintained more often than a UE-object association formed using a shared position. UE-object association maintenance may be performed using a periodic data collection schedule that periodically collects measurements of the UE and object associated with one another (e.g., periodic sensing measurements) to maintain the association. In some aspects, the network node 604 may schedule additional data to be collected if no object is found to be associated with a PAUE, or if the accuracy of a UE-object association is calculated to be below a threshold metric.

The network node 604 may transmit the set of UE-object association profiles 634 to the wireless device 602 that requested the UE-object association. In some aspects, the network node 604 may transmit the set of UE-object association profiles 638 to at least some of the set of network nodes 606, such as a network node serving an area of interest indicated by the UE-object association request 610, or a network node scheduled to perform periodic sensing to maintain a UE-object association. A UE-object association profile may include information about the associated object, such as a measured position, size, shape, orientation, speed, micro-Doppler profile, or posture of the associated object.

In some aspects, the network node 604 may transmit the set of UE-object association profiles 636 to at least some of the set of UEs associated with the set of UE-object association profiles 636, such as a PAUE that has a UE-object association, or a PAUE that is scheduled to perform periodic sensing to maintain a UE-object association. The network node 604 may transmit a new UE measurement indication to the PAUE to maintain the association. For example, the PAUE may maintain the association for MPE detection or beam management. The indication may be in the same format as a pervious indication before the data collection step, but with new settings. For example, the indication may be transmitted via a system information message, RRC signaling, a MAC-CE, and/or DCI. The network node 604 may schedule which measurements to take at which time periods, and may schedule the measurements based upon power consumption, data size, and efficiency of the measurements. The UE-object association maintenance may be scheduled at 618 by the network node 604 for the UEs and objects that have UE-object associations, and not for an entire area of interest.

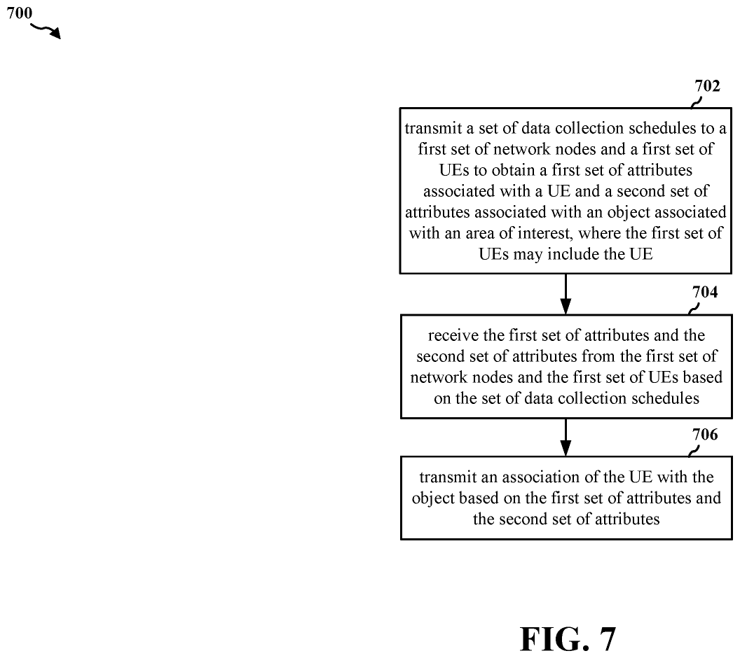

FIG. 7 is a flowchart 700 of a method of wireless communication. The method may be performed by a network node (e.g., the base station 102, the base station 310; the wireless device 402, the wireless device 404, the wireless device 406, the wireless device 408; the RSU 502; the TRP 504, the TRP 506; the network node 604; the network entity 1102, the network entity 1202, the network entity 1360). At 702, the network node may transmit a set of data collection schedules to a first set of network nodes and a first set of UEs to obtain a first set of attributes associated with a UE and a second set of attributes associated with an object associated with an area of interest. The first set of UEs may include the UE. For example, 702 may be performed by the network node 604 in FIG. 6, which may transmit the set of data collection schedules 620 to the first set of network nodes 606 and the set of data collection schedules 626 to the first set of PAUEs 608 to obtain a first set of attributes associated with the first set of PAUEs 608, and a second set of attributes associated with a target object associated with an area of interest about the target object from the set of data collection reports 624 and/or the set of data collection reports 630. Moreover, 702 may be performed by the component 199 in FIG. 1, 12, or 13.

At 704, the network node may receive the first set of attributes and the second set of attributes from the first set of network nodes and the first set of UEs based on the set of data collection schedules. For example, 704 may be performed by the network node 604 in FIG. 6, which may receive the first set of attributes associated with the set of PAUEs 608 and the second set of attributes associated with the target object from the set of network nodes 606 as the set of data collection reports 624 and/or from the set of PAUEs 608 as the set of data collection reports 630 based on the set of data collection schedules, such as the set of data collection schedules 620 and the set of data collection schedules 626. Moreover, 704 may be performed by the component 199 in FIG. 1, 12, or 13.

At 706, the network node may transmit an association of the UE with the object based on the first set of attributes and the second set of attributes. For example, 706 may be performed by the network node 604 in FIG. 6, which may transmit the set of UE-object association profiles 634 to the wireless device 602, the set of UE-object association profiles 636 to at least some of the set of PAUEs 608, and/or the set of UE-object association profiles 638 to at least some of the set of network nodes 606 based on the first set of attributes and the second set of attributes. Moreover, 706 may be performed by the component 199 in FIG. 1, 12, or 13.

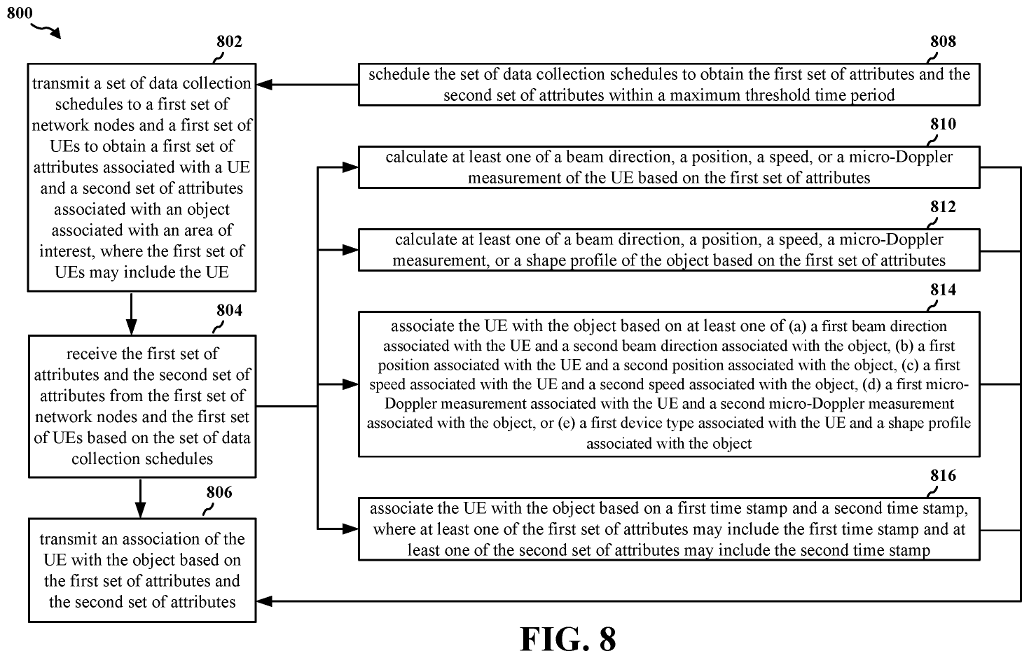

FIG. 8 is a flowchart 800 of a method of wireless communication. The method may be performed by a network node (e.g., the base station 102, the base station 310; the wireless device 402, the wireless device 404, the wireless device 406, the wireless device 408; the RSU 502; the TRP 504, the TRP 506; the network node 604; the network entity 1102, the network entity 1202, the network entity 1360). At 802, the network node may transmit a set of data collection schedules to a first set of network nodes and a first set of UEs to obtain a first set of attributes associated with a UE and a second set of attributes associated with an object associated with an area of interest. The first set of UEs may include the UE. For example, 802 may be performed by the network node 604 in FIG. 6, which may transmit the set of data collection schedules 620 to the first set of network nodes 606 and the set of data collection schedules 626 to the first set of PAUEs 608 to obtain a first set of attributes associated with the first set of PAUEs 608, and a second set of attributes associated with a target object associated with an area of interest about the target object from the set of data collection reports 624 and/or the set of data collection reports 630. Moreover, 802 may be performed by the component 199 in FIG. 1, 12, or 13.

At 804, the network node may receive the first set of attributes and the second set of attributes from the first set of network nodes and the first set of UEs based on the set of data collection schedules. For example, 804 may be performed by the network node 604 in FIG. 6, which may receive the first set of attributes associated with the set of PAUEs 608 and the second set of attributes associated with the target object from the set of network nodes 606 as the set of data collection reports 624 and/or from the set of PAUEs 608 as the set of data collection reports 630 based on the set of data collection schedules, such as the set of data collection schedules 620 and the set of data collection schedules 626. Moreover, 804 may be performed by the component 199 in FIG. 1, 12, or 13.

At 806, the network node may transmit an association of the UE with the object based on the first set of attributes and the second set of attributes. For example, 806 may be performed by the network node 604 in FIG. 6, which may transmit the set of UE-object association profiles 634 to the wireless device 602, the set of UE-object association profiles 636 to at least some of the set of PAUEs 608, and/or the set of UE-object association profiles 638 to at least some of the set of network nodes 606 based on the first set of attributes and the second set of attributes. Moreover, 806 may be performed by the component 199 in FIG. 1, 12, or 13.

At 808, the network node may schedule the set of data collection schedules to obtain the first set of attributes and the second set of attributes within a maximum threshold time period. For example, 808 may be performed by the network node 604 in FIG. 6, which may schedule the set of data collection schedules 620 and/or the set of data collection schedules 626 to obtain the first set of attributes and the second set of attributes within a maximum threshold time period. In some aspects, the network node 604 may schedule the first set of attributes and the second set of attributes to be collected within a 1 second, 2 second, or 5 second time frame, or may schedule the first set of attributes and the second set of attributes to be collected within 0.2, 0.5, or 1 second of one another to ensure that data associated with a moving object and/or PAUE can be associated with one another accurately. Moreover, 808 may be performed by the component 199 in FIG. 1, 12, or 13.

At 810, the network node may calculate at least one of a beam direction, a position, a speed, or a micro-Doppler measurement of the UE based on the first set of attributes. For example, 810 may be performed by the network node 604 in FIG. 6, which may, at 618, calculate at least one of a beam direction, a position, a speed, or a micro-Doppler measurement of the set of PAUEs 608 based on the first set of attributes of the set of PAUEs 608 from the UE-object association capability feedback 616. Moreover, 810 may be performed by the component 199 in FIG. 1, 12, or 13.

At 812, the network node may calculate at least one of a beam direction, a position, a speed, a micro-Doppler measurement, or a shape profile of the object based on the first set of attributes. For example, 812 may be performed by the network node 604 in FIG. 6, which may, at 632, calculate at least one of a beam direction, a position, a speed, a micro-Doppler measurement, or a shape profile of the object based on the first set of attributes of the set of PAUEs 608, UE-object association capability feedback 616, the set of data collection reports 624, and/or the set of data collection reports 630. Moreover, 812 may be performed by the component 199 in FIG. 1, 12, or 13.

At 814, the network node may associate the UE with the object based on at least one of (a) a first beam direction associated with the UE and a second beam direction associated with the object, (b) a first position associated with the UE and a second position associated with the object, (c) a first speed associated with the UE and a second speed associated with the object, (d) a first micro-Doppler measurement associated with the UE and a second micro-Doppler measurement associated with the object, or (e) a first device type associated with the UE and a shape profile associated with the object. For example, 814 may be performed by the network node 604 in FIG. 6, which may associate one of the set of PAUEs 608 with an object based on at least one of (a) a first beam direction associated with one of the set of PAUEs 608 and a second beam direction associated with the object, (b) a first position associated with one of the set of PAUEs 608 and a second position associated with the object, (c) a first speed associated with one of the set of PAUEs 608 and a second speed associated with the object, (d) a first micro-Doppler measurement associated with one of the set of PAUEs 608 and a second micro-Doppler measurement associated with the object, or (e) a first device type associated with one of the set of PAUEs 608 and a shape profile associated with the object. For example, if the first beam direction and the second beam direction are within a threshold metric of one another (e.g., within 5 degrees), if the first position and the second position are within a threshold metric of one another (e.g., within 1 meter, if the first speed and the second speed are within a threshold metric of one another (e.g., within 5 mph), if the first micro-Doppler measurement and the second micro-Doppler measurement are within a threshold metric of one another (e.g., vibrating within 1 m/s²), the network node 604 may associate one of the set of PAUEs 608 with the object sharing the same or similar qualities. If the object has a shape that indicates that it is holding a mobile phone, and the device type of one of the set of PAUEs 608 indicates that it is a mobile phone, then the network node 604 may associate the PAUE with the object. Moreover, 814 may be performed by the component 199 in FIG. 1, 12, or 13.

At 816, the network node may associate the UE with the object based on a first time stamp and a second time stamp. At least one of the first set of attributes may include the first time stamp and at least one of the second set of attributes may include the second time stamp. For example, 816 may be performed by the network node 604 in FIG. 6, which may associate one of the set of PAUEs 608 with an object based on a first time stamp of a first measured attribute and a second time stamp of a second measured attribute. At least one of the first set of attributes may include the first time stamp and at least one of the second set of attributes may include the second time stamp, allowing for the network node 604 to correlate attributes of a PAUE with attributes of an object if the measurements used to calculate the attributes were taken asynchronously. Moreover, 816 may be performed by the component 199 in FIG. 1, 12, or 13.

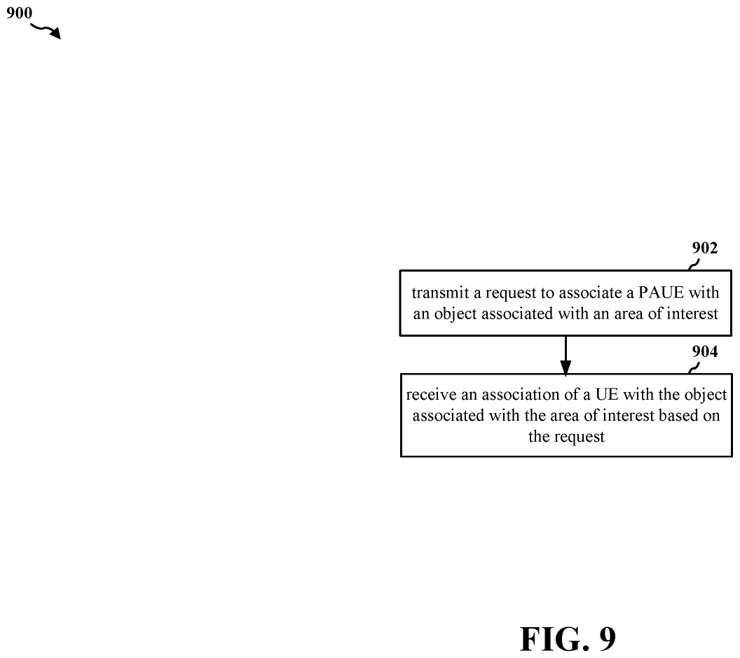

FIG. 9 is a flowchart 900 of a method of wireless communication. The method may be performed by a wireless device (e.g., the UE 104, the UE 350, the UE 512, the UE 514, the UE 532, the UE 534, the UE 536, the UE 552, the UE 554; the base station 102, the base station 310; the wireless device 402, the wireless device 404, the wireless device 406, the wireless device 408, the wireless device 602; the RSU 502; the TRP 504, the TRP 506; the apparatus 1104; the network entity 1102, the network entity 1202, the network entity 1360). At 902, the wireless device may transmit a request to associate a PAUE with an object associated with an area of interest. For example, 902 may be performed by the wireless device 602 in FIG. 6, which may transmit the UE-object association request 610 to the network node 604 to associate a PAUE with an object associated with an area of interest. Moreover, 902 may be performed by the component 198 in FIG. 1, 11, 12, or 13.

At 904, the wireless device may receive an association of a UE with the object associated with the area of interest based on the request. For example, 904 may be performed by the wireless device 602 in FIG. 6, which may receive the set of UE-object association profiles 634 from the network node 604, which may indicate an association of a UE with the object associated with the area of interest based on the UE-object association request 610. Moreover, 904 may be performed by the component 198 in FIG. 1, 11, 12, or 13.

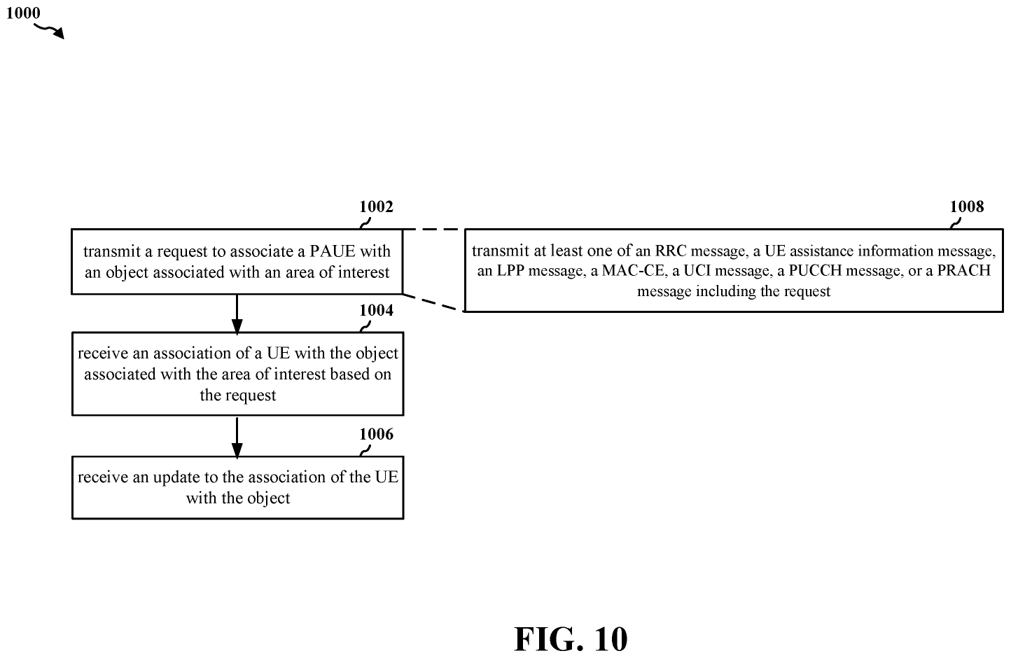

FIG. 10 is a flowchart 1000 of a method of wireless communication. The method may be performed by a wireless device (e.g., the UE 104, the UE 350, the UE 512, the UE 514, the UE 532, the UE 534, the UE 536, the UE 552, the UE 554; the base station 102, the base station 310; the wireless device 402, the wireless device 404, the wireless device 406, the wireless device 408, the wireless device 602; the RSU 502; the TRP 504, the TRP 506; the apparatus 1104; the network entity 1102, the network entity 1202, the network entity 1360). At 1002, the wireless device may transmit a request to associate a PAUE with an object associated with an area of interest. For example, 902 may be performed by the wireless device 602 in FIG. 6, which may transmit the UE-object association request 610 to the network node 604 to associate a PAUE with an object associated with an area of interest. Moreover, 1002 may be performed by the component 198 in FIG. 1, 11, 12, or 13.

At 1004, the wireless device may receive an association of a UE with the object associated with the area of interest based on the request. For example, 1004 may be performed by the wireless device 602 in FIG. 6, which may receive the set of UE-object association profiles 634 from the network node 604, which may indicate an association of a UE with the object associated with the area of interest based on the UE-object association request 610. Moreover, 1004 may be performed by the component 198 in FIG. 1, 11, 12, or 13.

At 1006, the wireless device may receive an update to the association of the UE with the object. For example, 1006 may be performed by the wireless device 602 in FIG. 6, which may receive an update to the association of the UE with the object as the set of UE-object association profiles 634. The network node 604 may schedule Moreover, 1006 may be performed by the component 198 in FIG. 1, 11, 12, or 13.

At 1008, the wireless device may transmit at least one of an RRC message, a UE assistance information message, an LPP message, a MAC-CE, a UCI message, a PUCCH message, or a PRACH message including the request. For example, 1008 may be performed by the wireless device 602 in FIG. 6, which may transmit the UE-object association request 610 in at least one of an RRC message, a UE assistance information message, an LPP message, a MAC-CE, a UCI message, a PUCCH message, or a PRACH message. Moreover, 1008 may be performed by the component 198 in FIG. 1, 11, 12, or 13.

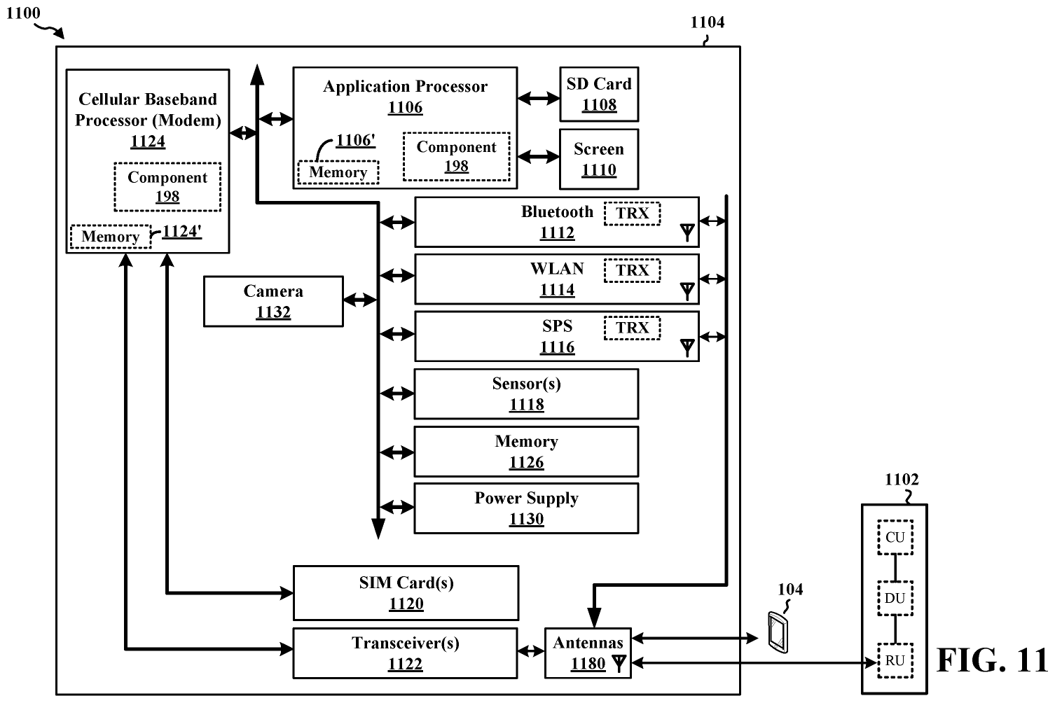

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include a cellular baseband processor 1124 (also referred to as a modem) coupled to one or more transceivers 1122 (e.g., cellular RF transceiver). The cellular baseband processor 1124 may include on-chip memory 1124′. In some aspects, the apparatus 1104 may further include one or more subscriber identity modules (SIM) cards 1120 and an application processor 1106 coupled to a secure digital (SD) card 1108 and a screen 1110. The application processor 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (Rx)). The Bluetooth module 1112, the WLAN module 1114, and the SPS module 1116 may include their own dedicated antennas and/or utilize the antennas 1180 for communication. The cellular baseband processor 1124 communicates through the transceiver(s) 1122 via one or more antennas 1180 with the UE 104 and/or with an RU associated with a network entity 1102. The cellular baseband processor 1124 and the application processor 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor 1124 and the application processor 1106 are each responsible for general processing, including the execution of software stored on the computer-readable medium/memory. The software, when executed by the cellular baseband processor 1124/application processor 1106, causes the cellular baseband processor 1124/application processor 1106 to perform the various functions described supra. The computer-readable medium/memory may also be used for storing data that is manipulated by the cellular baseband processor 1124/application processor 1106 when executing software. The cellular baseband processor 1124/application processor 1106 may be a component of the UE 350 and may include the memory 360 and/or at least one of the Tx processor 368, the Rx processor 356, and the controller/processor 359. In one configuration, the apparatus 1104 may be a processor chip (modem and/or application) and include just the cellular baseband processor 1124 and/or the application processor 1106, and in another configuration, the apparatus 1104 may be the entire UE (e.g., see UE 350 of FIG. 3) and include the additional modules of the apparatus 1104.

As discussed supra, the component 198 may be configured to transmit a request to associate a PAUE with an object associated with an area of interest. The component 198 may be configured to receive an association of a UE with the object associated with the area of interest based on the request. The component 198 may be within the cellular baseband processor 1124, the application processor 1106, or both the cellular baseband processor 1124 and the application processor 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1104 may include a variety of components configured for various functions. In one configuration, the apparatus 1104, and in particular the cellular baseband processor 1124 and/or the application processor 1106, may include means for transmitting a request to associate a PAUE with an object associated with an area of interest. The apparatus 1104 may include means for receiving an association of a UE with the object associated with the area of interest based on the request. The association of the UE with the object may be based on at least one of (a) a first beam direction associated with the UE and a second beam direction associated with the object, (b) a first position associated with the UE and a second position associated with the object, (c) a first speed associated with the UE and a second speed associated with the object, (d) a first micro-Doppler measurement associated with the UE and a second micro-Doppler measurement associated with the object, or (e) a first device type associated with the UE and a shape profile associated with the object. The apparatus 1104 may include means for receiving an update to the association of the UE with the object. The update to the association may include at least one of a position, a size, a shape, an orientation, a speed, or a micro-Doppler measurement associated with the object. The apparatus 1104 may include at least one of a second UE, a TRP, or a second network node. The apparatus 1104 may include means for transmitting the request by transmitting at least one of an RRC message, a UE assistance information message, an LPP message, a MAC-CE, a UCI message, a PUCCH message, or a PRACH message including the request. The request may include at least one of (a) a first indication of the area of interest, (b) a previous association of the PAUE with the object, or (c) a second indication of a set of UEs associated with the area of interest. The means may be the component 198 of the apparatus 1104 configured to perform the functions recited by the means. As described supra, the apparatus 1104 may include the Tx processor 368, the Rx processor 356, and the controller/processor 359. As such, in one configuration, the means may be the Tx processor 368, the Rx processor 356, and/or the controller/processor 359 configured to perform the functions recited by the means.

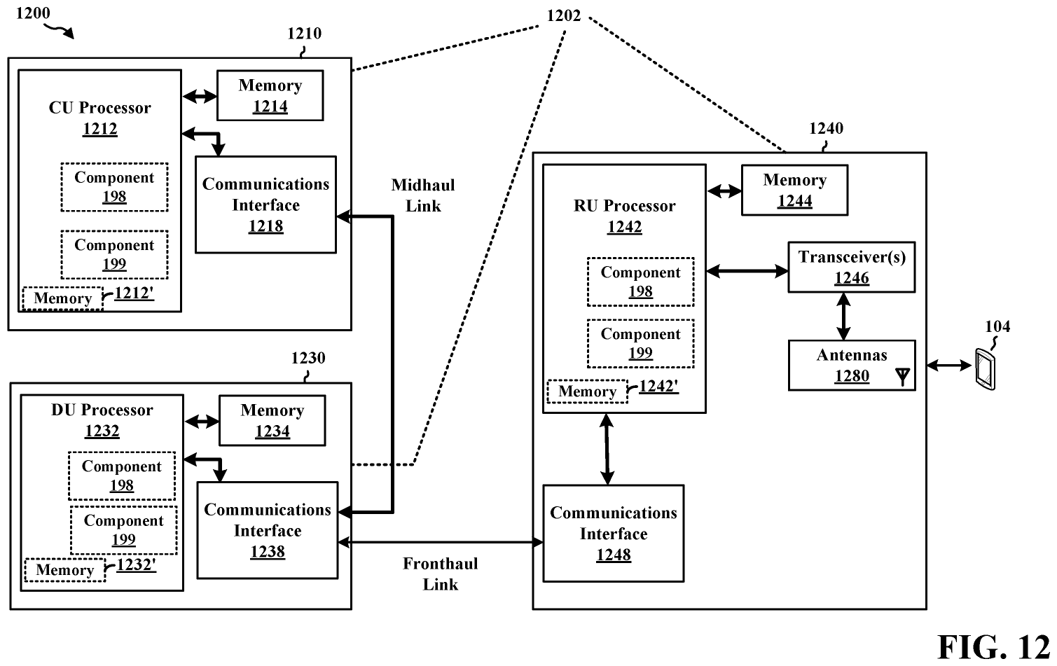

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include a CU processor 1212. The CU processor 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include a DU processor 1232. The DU processor 1232 may include on-chip memory 1232′. In some aspects, the DU 1230 may further include additional memory modules 1234 and a communications interface 1238. The DU 1230 communicates with the RU 1240 through a fronthaul link. The RU 1240 may include an RU processor 1242. The RU processor 1242 may include on-chip memory 1242′. In some aspects, the RU 1240 may further include additional memory modules 1244, one or more transceivers 1246, antennas 1280, and a communications interface 1248. The RU 1240 communicates with the UE 104. The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 198 may be configured to transmit a request to associate a PAUE with an object associated with an area of interest. The component 198 may be configured to receive an association of a UE with the object associated with the area of interest based on the request. The component 198 may be within one or more processors of one or more of the CU 1210, DU 1230, and the RU 1240. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1202 may include a variety of components configured for various functions. In one configuration, the network entity 1202 may include means for transmitting a request to associate a PAUE with an object associated with an area of interest. The network entity 1202 may include means for receiving an association of a UE with the object associated with the area of interest based on the request. The association of the UE with the object may be based on at least one of (a) a first beam direction associated with the UE and a second beam direction associated with the object, (b) a first position associated with the UE and a second position associated with the object, (c) a first speed associated with the UE and a second speed associated with the object, (d) a first micro-Doppler measurement associated with the UE and a second micro-Doppler measurement associated with the object, or (e) a first device type associated with the UE and a shape profile associated with the object. The network entity 1202 may include means for receiving an update to the association of the UE with the object. The update to the association may include at least one of a position, a size, a shape, an orientation, a speed, or a micro-Doppler measurement associated with the object. The network entity 1202 may include at least one of a second UE, a TRP, or a second network node. The network entity 1202 may include means for transmitting the request by transmitting at least one of an RRC message, a UE assistance information message, an LPP message, a MAC-CE, a UCI message, a PUCCH message, or a PRACH message including the request. The request may include at least one of (a) a first indication of the area of interest, (b) a previous association of the PAUE with the object, or (c) a second indication of a set of UEs associated with the area of interest. The means may be the component 198 of the network entity 1202 configured to perform the functions recited by the means. As described supra, the network entity 1202 may include the Tx processor 316, the Rx processor 370, and the controller/processor 375. As such, in one configuration, the means may be the Tx processor 316, the Rx processor 370, and/or the controller/processor 375 configured to perform the functions recited by the means.

As discussed supra, the component 199 may be configured to transmit a set of data collection schedules to a first set of network nodes and a first set of UEs to obtain a first set of attributes associated with a UE and a second set of attributes associated with an object associated with an area of interest. The first set of UEs may include the UE. The component 199 may be configured to receive the first set of attributes and the second set of attributes from the first set of network nodes and the first set of UEs based on the set of data collection schedules. The first set of UEs may include the UE. The component 199 may be configured to transmit an association of the UE with the object based on the first set of attributes and the second set of attributes. The component 199 may be within one or more processors of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1202 may include a variety of components configured for various functions. In one configuration, the network entity 1202 may include means for transmitting a set of data collection schedules to a first set of network nodes and a first set of UEs to obtain a first set of attributes associated with a UE and a second set of attributes associated with an object associated with an area of interest. The network entity 1202 may include means for transmitting a set of data collection schedules to a first set of network nodes and a first set of UEs to obtain a first set of attributes associated with a UE and a second set of attributes associated with an object associated with an area of interest. The first set of UEs may include the UE. The network entity 1202 may include means for receiving the first set of attributes and the second set of attributes from the first set of network nodes and the first set of UEs based on the set of data collection schedules. The network entity 1202 may include means for transmitting an association of the UE with the object based on the first set of attributes and the second set of attributes. The first network node may include at least one of a sensing server or a TRP. The network entity 1202 may include means for calculating at least one of a beam direction, a position, a speed, or a Doppler measurement of the UE based on the first set of attributes. The network entity 1202 may include means for calculating at least one of a beam direction, a position, a speed, a micro-Doppler measurement, or a shape profile of the object based on the first set of attributes. The network entity 1202 may include means for associating the UE with the object based on at least one of (a) a first beam direction associated with the UE and a second beam direction associated with the object, (b) a first position associated with the UE and a second position associated with the object, (c) a first speed associated with the UE and a second speed associated with the object, (d) a first micro-Doppler measurement associated with the UE and a second micro-Doppler measurement associated with the object, or (e) a first device type associated with the UE and a shape profile associated with the object. The network entity 1202 may include means for scheduling the set of data collection schedules to obtain the first set of attributes and the second set of attributes within a maximum threshold time period. At least one of the first set of attributes may include a first time stamp and at least one of the second set of attributes may include a second time stamp. The network entity 1202 may include means for associating the UE with the object based on the first time stamp and the second time stamp. The network entity 1202 may include means for transmitting the set of data collection schedules by transmitting at least one of an RRC message, a MAC-CE, DCI, or system information broadcast including the set of data collection schedules. The network entity 1202 may include means for receiving the first set of attributes and the second set of attributes by receiving at least one of an RRC message, a UE assistance information message, an LPP message, a MAC-CE, an UCI message, a PUCCH message, or a PRACH message including the first set of attributes or the second set of attributes. The network entity 1202 may include means for receiving a first update to the first set of attributes and the second set of attributes from the first set of network nodes and the first set of UEs based on at least one of the set of data collection schedules or a new set of data collection schedules. The second update to the association may include at least one of a position, a size, a shape, an orientation, a speed, or a micro-Doppler measurement associated with the object. The network entity 1202 may include means for transmitting a second update to the association of the UE with the object based on the first update to the first set of attributes and the second set of attributes. The network entity 1202 may include means for transmitting a set of object identifiers associated with a set of objects to the UE. The network entity 1202 may include means for receiving a selection of a subset of the set of objects from the UE. The transmission of the association of the UE with the object may be further based on the selection of the subset of the set of objects. The network entity 1202 may include means for receiving a request to associate a PAUE with the object associated with the area of interest. The transmission of the set of data collection schedules may be in response to the request to associate the PAUE with the object. The network entity 1202 may include means for receiving the request by receiving the request from at least one of a second UE, a TRP, or a second network node. The network entity 1202 may include means for receiving the request by receiving at least one of an RRC message, a UE assistance information message, an LPP message, a MAC-CE, an UCI message, a PUCCH message, or a PRACH message including the request. The request may include at least one of (a) a first indication of the area of interest, (b) a previous association of the PAUE with the object, or (c) a second indication of a second set of UEs associated with the area of interest. The network entity 1202 may include means for receiving a set of network node capability information associated with a second set of network nodes. The second set of network nodes may include the first set of network nodes. The network entity 1202 may include means for receiving a set of UE capability information associated with a second set of UEs. The second set of UEs may include the first set of UEs. The network entity 1202 may include means for selecting the first set of network nodes for the transmission of the set of data collection schedules based on the set of network node capability information. The network entity 1202 may include means for selecting the first set of UEs for the transmission of the set of data collection schedules based on the set of UE capability information. The network entity 1202 may include means for transmitting a network node capability enquiry to the second set of network nodes. The reception of the set of network node capability information may be in response to the transmission of the network node capability enquiry. The network entity 1202 may include means for transmitting a UE capability enquiry to the second set of UEs. The reception of the set of UE capability information may be in response to the transmission of the UE capability enquiry. The means may be the component 199 of the network entity 1202 configured to perform the functions recited by the means. As described supra, the network entity 1202 may include the Tx processor 316, the Rx processor 370, and the controller/processor 375. As such, in one configuration, the means may be the Tx processor 316, the Rx processor 370, and/or the controller/processor 375 configured to perform the functions recited by the means.

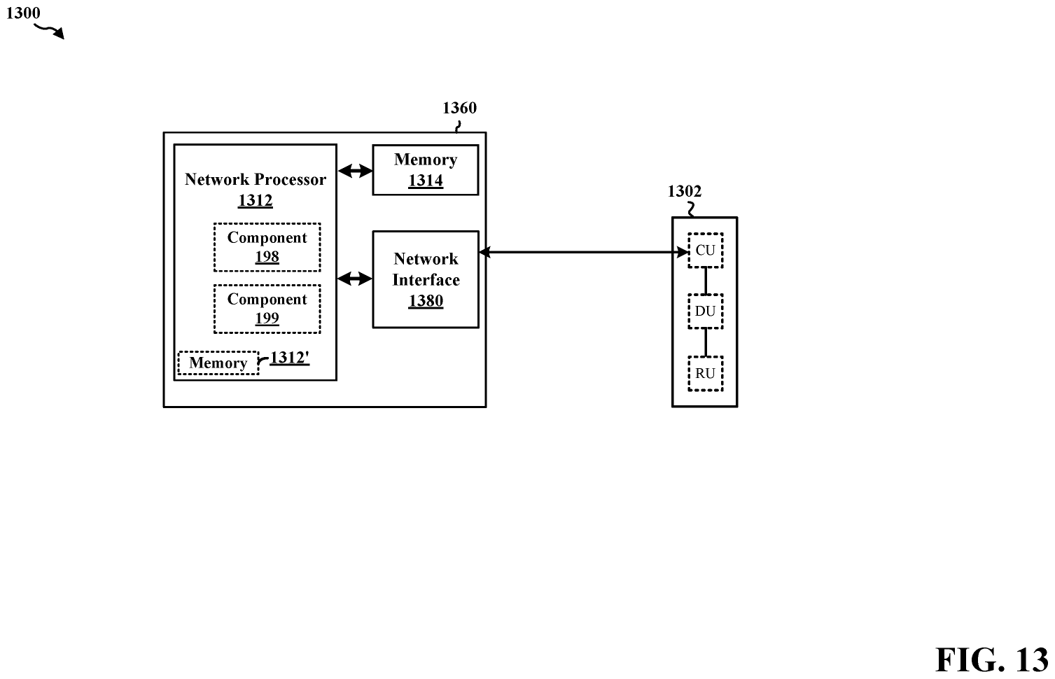

FIG. 13 is a diagram 1300 illustrating an example of a hardware implementation for a network entity 1360. In one example, the network entity 1360 may be within the core network 120. The network entity 1360 may include a network processor 1312. The network processor 1312 may include on-chip memory 1312′. In some aspects, the network entity 1360 may further include additional memory modules 1314. The network entity 1360 communicates via the network interface 1380 directly (e.g., backhaul link) or indirectly (e.g., through a RIC) with the CU 1302. The on-chip memory 1312′ and the additional memory modules 1314 may each be considered a computer-readable medium/memory. Each computer-readable medium/memory may be non-transitory. The processor 1312 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 198 may be configured to transmit a request to associate a PAUE with an object associated with an area of interest. The component 198 may be configured to receive an association of a UE with the object associated with the area of interest based on the request. The component 198 may be within the processor 1312. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1360 may include a variety of components configured for various functions. In one configuration, the network entity 1360 may include means for transmitting a request to associate a PAUE with an object associated with an area of interest. The network entity 1360 may include means for receiving an association of a UE with the object associated with the area of interest based on the request. The association of the UE with the object may be based on at least one of (a) a first beam direction associated with the UE and a second beam direction associated with the object, (b) a first position associated with the UE and a second position associated with the object, (c) a first speed associated with the UE and a second speed associated with the object, (d) a first micro-Doppler measurement associated with the UE and a second micro-Doppler measurement associated with the object, or (e) a first device type associated with the UE and a shape profile associated with the object. The network entity 1360 may include means for receiving an update to the association of the UE with the object. The update to the association may include at least one of a position, a size, a shape, an orientation, a speed, or a micro-Doppler measurement associated with the object. The network entity 1360 may include at least one of a second UE, a TRP, or a second network node. The network entity 1360 may include means for transmitting the request by transmitting at least one of an RRC message, a UE assistance information message, an LPP message, a MAC-CE, a UCI message, a PUCCH message, or a PRACH message including the request. The request may include at least one of (a) a first indication of the area of interest, (b) a previous association of the PAUE with the object, or (c) a second indication of a set of UEs associated with the area of interest. The means may be the component 198 of the network entity 1360 configured to perform the functions recited by the means.

As discussed supra, the component 199 may be configured to transmit a set of data collection schedules to a first set of network nodes and a first set of UEs to obtain a first set of attributes associated with a UE and a second set of attributes associated with an object associated with an area of interest. The first set of UEs may include the UE. The component 199 may be configured to receive the first set of attributes and the second set of attributes from the first set of network nodes and the first set of UEs based on the set of data collection schedules. The component 199 may be within the processor 1312. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1360 may include a variety of components configured for various functions. In one configuration, the network entity 1360 may include means for transmitting a set of data collection schedules to a first set of network nodes and a first set of UEs to obtain a first set of attributes associated with a UE and a second set of attributes associated with an object associated with an area of interest. The network entity 1360 may include means for transmitting a set of data collection schedules to a first set of network nodes and a first set of UEs to obtain a first set of attributes associated with a UE and a second set of attributes associated with an object associated with an area of interest. The first set of UEs may include the UE. The network entity 1360 may include means for receiving the first set of attributes and the second set of attributes from the first set of network nodes and the first set of UEs based on the set of data collection schedules. The network entity 1360 may include means for transmitting an association of the UE with the object based on the first set of attributes and the second set of attributes. The first network node may include at least one of a sensing server or a TRP. The network entity 1360 may include means for calculating at least one of a beam direction, a position, a speed, or a Doppler measurement of the UE based on the first set of attributes. The network entity 1360 may include means for calculating at least one of a beam direction, a position, a speed, a micro-Doppler measurement, or a shape profile of the object based on the first set of attributes. The network entity 1360 may include means for associating the UE with the object based on at least one of (a) a first beam direction associated with the UE and a second beam direction associated with the object, (b) a first position associated with the UE and a second position associated with the object, (c) a first speed associated with the UE and a second speed associated with the object, (d) a first micro-Doppler measurement associated with the UE and a second micro-Doppler measurement associated with the object, or (e) a first device type associated with the UE and a shape profile associated with the object. The network entity 1360 may include means for scheduling the set of data collection schedules to obtain the first set of attributes and the second set of attributes within a maximum threshold time period. At least one of the first set of attributes may include a first time stamp and at least one of the second set of attributes may include a second time stamp. The network entity 1360 may include means for associating the UE with the object based on the first time stamp and the second time stamp. The network entity 1360 may include means for transmitting the set of data collection schedules by transmitting at least one of an RRC message, a MAC-CE, DCI, or system information broadcast including the set of data collection schedules. The network entity 1360 may include means for receiving the first set of attributes and the second set of attributes by receiving at least one of an RRC message, a UE assistance information message, an LPP message, a MAC-CE, an UCI message, a PUCCH message, or a PRACH message including the first set of attributes or the second set of attributes. The network entity 1360 may include means for receiving a first update to the first set of attributes and the second set of attributes from the first set of network nodes and the first set of UEs based on at least one of the set of data collection schedules or a new set of data collection schedules. The second update to the association may include at least one of a position, a size, a shape, an orientation, a speed, or a micro-Doppler measurement associated with the object. The network entity 1360 may include means for transmitting a second update to the association of the UE with the object based on the first update to the first set of attributes and the second set of attributes. The network entity 1360 may include means for transmitting a set of object identifiers associated with a set of objects to the UE. The network entity 1360 may include means for receiving a selection of a subset of the set of objects from the UE. The transmission of the association of the UE with the object may be further based on the selection of the subset of the set of objects. The network entity 1360 may include means for receiving a request to associate a PAUE with the object associated with the area of interest. The transmission of the set of data collection schedules may be in response to the request to associate the PAUE with the object. The network entity 1360 may include means for receiving the request by receiving the request from at least one of a second UE, a TRP, or a second network node. The network entity 1360 may include means for receiving the request by receiving at least one of an RRC message, a UE assistance information message, an LPP message, a MAC-CE, an UCI message, a PUCCH message, or a PRACH message including the request. The request may include at least one of (a) a first indication of the area of interest, (b) a previous association of the PAUE with the object, or (c) a second indication of a second set of UEs associated with the area of interest. The network entity 1360 may include means for receiving a set of network node capability information associated with a second set of network nodes. The second set of network nodes may include the first set of network nodes. The network entity 1360 may include means for receiving a set of UE capability information associated with a second set of UEs. The second set of UEs may include the first set of UEs. The network entity 1360 may include means for selecting the first set of network nodes for the transmission of the set of data collection schedules based on the set of network node capability information. The network entity 1360 may include means for selecting the first set of UEs for the transmission of the set of data collection schedules based on the set of UE capability information. The network entity 1360 may include means for transmitting a network node capability enquiry to the second set of network nodes. The reception of the set of network node capability information may be in response to the transmission of the network node capability enquiry. The network entity 1360 may include means for transmitting a UE capability enquiry to the second set of UEs. The reception of the set of UE capability information may be in response to the transmission of the UE capability enquiry. The means may be the component 199 of the network entity 1360 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data.

The following aspects are illustrative only and may be combined with other aspects or teachings described herein, without limitation.

Aspect 1 is a method of wireless communication at a first network node, where the method may include transmitting a set of data collection schedules to a first set of network nodes and a first set of UEs to obtain a first set of attributes associated with a UE and a second set of attributes associated with an object associated with an area of interest. The first set of UEs may include the UE. The method may include receiving the first set of attributes and the second set of attributes from the first set of network nodes and the first set of UEs based on the set of data collection schedules. The method may include transmitting an association of the UE with the object based on the first set of attributes and the second set of attributes.

Aspect 2 is the method of aspect 1, where the first network node may include at least one of a sensing server or a TRP.

Aspect 3 is the method of either of aspects 1 or 2, where the method may include calculating at least one of a beam direction, a position, a speed, or a Doppler measurement of the UE based on the first set of attributes.

Aspect 4 is the method of any of aspects 1 to 3, where the method may include calculating at least one of a beam direction, a position, a speed, a micro-Doppler measurement, or a shape profile of the object based on the first set of attributes.

Aspect 5 is the method of any of aspects 1 to 4, where the method may include associating the UE with the object based on at least one of (a) a first beam direction associated with the UE and a second beam direction associated with the object, (b) a first position associated with the UE and a second position associated with the object, (c) a first speed associated with the UE and a second speed associated with the object, (d) a first micro-Doppler measurement associated with the UE and a second micro-Doppler measurement associated with the object, or (e) a first device type associated with the UE and a shape profile associated with the object.

Aspect 6 is the method of any of aspects 1 to 5, where the method may include scheduling the set of data collection schedules to obtain the first set of attributes and the second set of attributes within a maximum threshold time period.

Aspect 7 is the method of any of aspects 1 to 6, where at least one of the first set of attributes may include a first time stamp and at least one of the second set of attributes may include a second time stamp. The method may include associating the UE with the object based on the first time stamp and the second time stamp.

Aspect 8 is the method of any of aspects 1 to 7, where transmitting the set of data collection schedules may include transmitting at least one of an RRC message, a MAC-CE, DCI, or system information broadcast including the set of data collection schedules.

Aspect 9 is the method of any of aspects 1 to 8, where receiving the first set of attributes and the second set of attributes may include receiving at least one of an RRC message, a UE assistance information message, an LPP message, a MAC-CE, an UCI message, a PUCCH message, or a PRACH message including the first set of attributes or the second set of attributes.

Aspect 10 is the method of any of aspects 1 to 9, where the method may include receiving a first update to the first set of attributes and the second set of attributes from the first set of network nodes and the first set of UEs based on at least one of the set of data collection schedules or a new set of data collection schedules. The method may include transmitting a second update to the association of the UE with the object based on the first update to the first set of attributes and the second set of attributes.

Aspect 11 is the method of aspect 10, where the second update to the association may include at least one of a position, a size, a shape, an orientation, a speed, or a micro-Doppler measurement associated with the object.

Aspect 12 is the method of any of aspects 1 to 11, where the method may include transmitting a set of object identifiers associated with a set of objects to the UE. The method may include receiving a selection of a subset of the set of objects from the UE. The transmission of the association of the UE with the object may be further based on the selection of the subset of the set of objects.

Aspect 13 is the method of any of aspects 1 to 12, where the method may include receiving a request to associate a PAUE with the object associated with the area of interest. The transmission of the set of data collection schedules may be in response to the request to associate the PAUE with the object.

Aspect 14 is the method of aspect 13, where receiving the request may include receiving the request from at least one of a second UE, a TRP, or a second network node.

Aspect 15 is the method of either of aspects 13 or 14, where receiving the request may include receiving at least one of an RRC message, a UE assistance information message, an LPP message, a MAC-CE, an UCI message, a PUCCH message, or a PRACH message including the request.

Aspect 16 is the method of any of aspects 13 to 15, where the request may include at least one of (a) a first indication of the area of interest, (b) a previous association of the PAUE with the object, or (c) a second indication of a second set of UEs associated with the area of interest.

Aspect 17 is the method of any of aspects 1 to 16, where the method may include receiving a set of network node capability information associated with a second set of network nodes. The second set of network nodes may include the first set of network nodes. The method may include receiving a set of UE capability information associated with a second set of UEs. The second set of UEs may include the first set of UEs. The method may include selecting the first set of network nodes for the transmission of the set of data collection schedules based on the set of network node capability information. The method may include selecting the first set of UEs for the transmission of the set of data collection schedules based on the set of UE capability information.

Aspect 18 is the method of aspect 17, where the method may include transmitting a network node capability enquiry to the second set of network nodes. The reception of the set of network node capability information may be in response to the transmission of the network node capability enquiry. The method may include transmitting a UE capability enquiry to the second set of UEs. The reception of the set of UE capability information may be in response to the transmission of the UE capability enquiry.

Aspect 19 is a method of wireless communication at a wireless device, where the method may include transmitting a request to associate a PAUE with an object associated with an area of interest. The method may include receiving an association of a UE with the object associated with the area of interest based on the request.

Aspect 20 is the method of aspect 19, where the association of the UE with the object may be based on at least one of (a) a first beam direction associated with the UE and a second beam direction associated with the object, (b) a first position associated with the UE and a second position associated with the object, (c) a first speed associated with the UE and a second speed associated with the object, (d) a first micro-Doppler measurement associated with the UE and a second micro-Doppler measurement associated with the object, or (e) a first device type associated with the UE and a shape profile associated with the object.

Aspect 21 is the method of either of aspects 19 or 20, where the method may include receiving an update to the association of the UE with the object.

Aspect 22 is the method of aspect 21, where the update to the association may include at least one of a position, a size, a shape, an orientation, a speed, or a micro-Doppler measurement associated with the object.

Aspect 23 is the method of any of aspects 19 to 22, where the wireless device may include at least one of a second UE, a TRP, or a second network node.

Aspect 24 is the method of any of aspects 19 to 23, where transmitting the request may include transmitting at least one of an RRC message, a UE assistance information message, an LPP message, a MAC-CE, a UCI message, a PUCCH message, or a PRACH message including the request.

Aspect 25 is the method of any of aspects 19 to 24, where the request may include at least one of (a) a first indication of the area of interest, (b) a previous association of the PAUE with the object, or (c) a second indication of a set of UEs associated with the area of interest.

Aspect 26 is an apparatus for wireless communication, including: a memory; and at least one processor coupled to the memory and, based at least in part on information stored in the memory, the at least one processor is configured to implement any of aspects 1 to 25.

Aspect 27 is the apparatus of aspect 26, further including at least one of an antenna or a transceiver coupled to the at least one processor.

Aspect 28 is an apparatus for wireless communication including means for implementing any of aspects 1 to 25.

Aspect 29 is a computer-readable medium (e.g., a non-transitory computer-readable medium) storing computer executable code, where the code when executed by a processor causes the processor to implement any of aspects 1 to 25.

What is claimed is:

1. An apparatus for wireless communication at a first network node, comprising:
a memory; and
at least one processor coupled to the memory and, based at least in part on information stored in the memory, the at least one processor is configured to:
transmit a set of data collection schedules to a first set of network nodes and a first set of user equipment (UEs) to obtain a first set of attributes associated with a user equipment (UE) and a second set of attributes associated with an object associated with an area of interest, wherein the first set of UEs comprises the UE;
receive the first set of attributes and the second set of attributes from the first set of network nodes and the first set of UEs based on the set of data collection schedules; and
transmit an association of the UE with the object based on the first set of attributes and the second set of attributes.

2. The apparatus of claim 1, wherein the first network node comprises at least one of a sensing server or a transmission reception point (TRP).

3. The apparatus of claim 1, wherein the at least one processor is further configured to:
calculate at least one of a beam direction, a position, a speed, or a micro-Doppler measurement of the UE based on the first set of attributes.

4. The apparatus of claim 1, wherein the at least one processor is further configured to:
calculate at least one of a beam direction, a position, a speed, a micro-Doppler measurement, or a shape profile of the object based on the first set of attributes.

5. The apparatus of claim 1, wherein the at least one processor is further configured to associate the UE with the object based on at least one of:
a first beam direction associated with the UE and a second beam direction associated with the object;
a first position associated with the UE and a second position associated with the object;
a first speed associated with the UE and a second speed associated with the object;
a first micro-Doppler measurement associated with the UE and a second micro-Doppler measurement associated with the object; or
a first device type associated with the UE and a shape profile associated with the object.

6. The apparatus of claim 1, wherein the at least one processor is further configured to:
schedule the set of data collection schedules to obtain the first set of attributes and the second set of attributes within a maximum threshold time period.

7. The apparatus of claim 1, wherein at least one of the first set of attributes comprises a first time stamp and at least one of the second set of attributes comprises a second time stamp, wherein the at least one processor is further configured to:
associate the UE with the object based on the first time stamp and the second time stamp.

8. The apparatus of claim 1, wherein, to transmit the set of data collection schedules, the at least one processor is configured to:
transmit at least one of a radio resource control (RRC) message, a medium access control (MAC) control element (MAC-CE), downlink control information (DCI), or system information broadcast comprising the set of data collection schedules.

9. The apparatus of claim 1, wherein, to receive the first set of attributes and the second set of attributes, the at least one processor is configured to:
receive at least one of a radio resource control (RRC) message, a UE assistance information message, a long term evolution (LTE) positioning protocol (LPP) message, a medium access control (MAC) control element (MAC-CE), an uplink control information (UCI) message, a physical uplink control channel (PUCCH) message, or a physical random access channel (PRACH) message comprising the first set of attributes or the second set of attributes.

10. The apparatus of claim 1, wherein the at least one processor is further configured to:
receive a first update to the first set of attributes and the second set of attributes from the first set of network nodes and the first set of UEs based on at least one of the set of data collection schedules or a new set of data collection schedules; and
transmit a second update to the association of the UE with the object based on the first update to the first set of attributes and the second set of attributes.

11. The apparatus of claim 10, wherein the second update to the association comprises at least one of a position, a size, a shape, an orientation, a speed, or a micro-Doppler measurement associated with the object.

12. The apparatus of claim 1, wherein the at least one processor is further configured to:
transmit a set of object identifiers associated with a set of objects to the UE; and
receive a selection of a subset of the set of objects from the UE, wherein transmitting the association of the UE with the object is further based on the selection of the subset of the set of objects.

13. The apparatus of claim 1, wherein the at least one processor is further configured to:
receive a request to associate a potential association UE (PAUE) with the object associated with the area of interest, wherein transmitting the set of data collection schedules is in response to the request to associate the PAUE with the object.

14. The apparatus of claim 13, wherein, to receive the request, the at least one processor is configured to:
receive the request from at least one of a second UE, a transmission reception point (TRP), or a second network node.

15. The apparatus of claim 13, wherein, to receive the request, the at least one processor is configured to:
receive at least one of a radio resource control (RRC) message, a UE assistance information message, a long term evolution (LTE) positioning protocol (LPP) message, a medium access control (MAC) control element (MAC-CE), an uplink control information (UCI) message, a physical uplink control channel (PUCCH) message, or a physical random access channel (PRACH) message comprising the request.

16. The apparatus of claim 13, wherein the request comprises at least one of:
a first indication of the area of interest;
a previous association of the PAUE with the object; or
a second indication of a second set of UEs associated with the area of interest.

17. The apparatus of claim 1, wherein the at least one processor is further configured to:
receive a set of network node capability information associated with a second set of network nodes, wherein the second set of network nodes comprises the first set of network nodes;
receive a set of UE capability information associated with a second set of UEs, wherein the second set of UEs comprises the first set of UEs;
select the first set of network nodes for transmitting the set of data collection schedules based on the set of network node capability information; and
select the first set of UEs for transmitting the set of data collection schedules based on the set of UE capability information.

18. The apparatus of claim 17, wherein the at least one processor is further configured to:
transmit a network node capability enquiry to the second set of network nodes, wherein receiving the set of network node capability information is in response to transmitting the network node capability enquiry; and
transmit a UE capability enquiry to the second set of UEs, wherein receiving the set of UE capability information is in response to transmitting the UE capability enquiry.

19. The apparatus of claim 1, further comprising a transceiver coupled to the at least one processor, the transceiver being configured to:
transmit the set of data collection schedules to the first set of network nodes and the first set of UEs to obtain the first set of attributes associated with the UE and the second set of attributes associated with the object associated with the area of interest;
receive the first set of attributes and the second set of attributes from the first set of network nodes and the first set of UEs based on the set of data collection schedules; and
transmit the association of the UE with the object based on the first set of attributes and the second set of attributes.

20. An apparatus for wireless communication at a wireless device, comprising:
a memory; and
at least one processor coupled to the memory and, based at least in part on information stored in the memory, the at least one processor is configured to:
transmit a request to associate a potential association user equipment (PAUE) with an object associated with an area of interest; and
receive an association of a user equipment (UE) with the object associated with the area of interest based on the request.

21. The apparatus of claim 20, wherein the association of the UE with the object is based on at least one of:
a first beam direction associated with the UE and a second beam direction associated with the object;
a first position associated with the UE and a second position associated with the object;
a first speed associated with the UE and a second speed associated with the object;
a first micro-Doppler measurement associated with the UE and a second micro-Doppler measurement associated with the object; or
a first device type associated with the UE and a shape profile associated with the object.

22. The apparatus of claim 20, wherein the at least one processor is further configured to:
receive an update to the association of the UE with the object.

23. The apparatus of claim 22, wherein the update to the association comprises at least one of a position, a size, a shape, an orientation, a speed, or a micro-Doppler measurement associated with the object.

24. The apparatus of claim 20, wherein the wireless device comprises at least one of a second UE, a transmission reception point (TRP), or a second network node.

25. The apparatus of claim 20, wherein, to transmit the request, the at least one processor is configured to:
transmit at least one of a radio resource control (RRC) message, a UE assistance information message, a long term evolution (LTE) positioning protocol (LPP) message, a medium access control (MAC) control element (MAC-CE), an uplink control information (UCI) message, a physical uplink control channel (PUCCH) message, or a physical random access channel (PRACH) message comprising the request.

26. The apparatus of claim 20, wherein the request comprises at least one of:
a first indication of the area of interest;
a previous association of the PAUE with the object; or
a second indication of a set of UEs associated with the area of interest.

27. The apparatus of claim 20, further comprising a transceiver coupled to the at least one processor, the transceiver being configured to:
transmit the request to associate the PAUE with the object associated with the area of interest; and
receive the association of the UE with the object associated with the area of interest based on the request.

28. A method of wireless communication at a first network node, comprising:
transmitting a set of data collection schedules to a first set of network nodes and a first set of user equipment (UEs) to obtain a first set of attributes associated with a user equipment (UE) and a second set of attributes associated with an object associated with an area of interest, wherein the first set of UEs comprises the UE;
receiving the first set of attributes and the second set of attributes from the first set of network nodes and the first set of UEs based on the set of data collection schedules; and
transmitting an association of the UE with the object based on the first set of attributes and the second set of attributes.

29. The method of claim 28, further comprising:
receiving a first update to the first set of attributes and the second set of attributes from the first set of network nodes and the first set of UEs based on at least one of the set of data collection schedules or a new set of data collection schedules; and
transmitting a second update to the association of the UE with the object based on the first update to the first set of attributes and the second set of attributes.

30. A method of wireless communication at a wireless device, comprising:
transmitting a request to associate a potential association user equipment (PAUE) with an object associated with an area of interest; and
receiving an association of a user equipment (UE) with the object associated with the area of interest based on the request.
